(19) United States
(12) Patent Application Publication
(10) Pub. No.: US 2018/0033425 A1
(43) Pub. Date: Feb. 1, 2018

(54) EVALUATION DEVICE AND EVALUATION METHOD

(71) Applicant: FUJITSU LIMITED, Kawasaki-shi (JP)

(72) Inventor: Shinji KIKUCHI, Yokohama (JP)

(73) Assignee: FUJITSU LIMITED, Kawasaki-shi (JP)

(21) Appl. No.: 15/658,557

(22) Filed: Jul. 25, 2017

(30) Foreign Application Priority Data
Jul. 28, 2016 (JP) 2016-148756
May 17, 2017 (JP) 2017-097903

(51) Int. Cl. G10L 15/01; G10L 15/18; G10L 15/19; G06F 17/28

(52) U.S. Cl. CPC G10L 15/01; G06F 17/2863; G10L 15/1815; G10L 15/19

(57) ABSTRACT

An evaluation device includes a memory and a processor coupled to the memory and the processor configured to acquire a first character string, to specify features of first meaning information and features of first sound information, the first meaning information corresponding to meanings denoted by the first character string, the first sound information corresponding to sounds denoted by the first character string, to determine a first evaluation value based on the features of the first meaning information, to determine a second evaluation value based on the features of the first sound information, and to output an evaluation value of the first character string based on the first evaluation value and the second evaluation value.

### CROSS-REFERENCE TO RELATED APPLICATION

This application is based upon and claims the benefit of priority of the prior Japanese Patent Application No. 2016-148756, filed on Jul. 28, 2016, and the prior Japanese Patent Application No. 2017-097903, filed on May 17, 2017, the entire contents of which are incorporated herein by reference.

### FIELD

The embodiments discussed herein are related to a technology of evaluating language description.

### BACKGROUND

A sentence correction tool detects a grammatical error included in a sentence. A sentence analysis tool charts dependency relations in sentences. The tool is useful for evaluating sentences that express logical contents like business documents or articles. This is because logical content of a grammatically correct and easily interpretable sentence is easily transferred.

A technology relating to this is disclosed in, for example, Japanese Laid-open Patent Publication No. 2005-136810 and Japanese Laid-open Patent Publication No. 2008-46425.

### SUMMARY

According to an aspect of the invention, an evaluation device includes a memory and a processor coupled to the memory and the processor configured to acquire a first character string, to specify features of first meaning information and features of first sound information, the first meaning information corresponding to meanings denoted by the first character string, the first sound information corresponding to sounds denoted by the first character string, to determine a first evaluation value based on the features of the first meaning information, to determine a second evaluation value based on the features of the first sound information, and to output an evaluation value of the first character string based on the first evaluation value and the second evaluation value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a module configuration example of an evaluation apparatus;

FIG. 2 is a diagram illustrating an example of teacher data;

FIG. 3 is a diagram illustrating an example of a meaning vector database;

FIG. 4 is a diagram illustrating an example of a voice notation database;

FIG. 5 is a diagram illustrating a procedure for calculating parameters relating to meaning;

FIG. 6 is a diagram illustrating an example of a neural network which is used for machine learning relating to meaning;

FIG. 7 is a diagram illustrating a procedure for calculating parameters relating to voice;

FIG. 8 is a diagram illustrating an example of a neural network which is used for machine learning relating to voice;

FIG. 9 is a diagram illustrating a module configuration example of a learning unit;

FIG. 10 is a diagram illustrating a learning processing flow;

FIG. 11 is a diagram illustrating an example of a first feature table;

FIG. 12 is a diagram illustrating an example of a first parameter table;

FIG. 13A is a diagram illustrating a first generation processing flow;

FIG. 13B is a diagram illustrating the first generation processing flow;

FIG. 14 is a diagram illustrating an example of a first notation table;

FIG. 15 is a diagram illustrating an example of a second notation table;

FIG. 16 is a diagram illustrating an example of a second feature table;

FIG. 17 is a diagram illustrating an example of a second parameter table;

FIG. 18A is a diagram illustrating a third generation processing flow;

FIG. 18B is a diagram illustrating the third generation processing flow;

FIG. 18C is a diagram illustrating the third generation processing flow;

FIG. 18D is a diagram illustrating the third generation processing flow;

FIG. 19 is a diagram illustrating a module configuration example of an evaluation unit;

FIG. 20 is a diagram illustrating an evaluation processing flow;

FIG. 21 is a diagram illustrating a fifth generation processing flow;

FIG. 22A is a diagram illustrating a sixth generation processing flow;

FIG. 22B is a diagram illustrating the sixth generation processing flow;

FIG. 23 is a diagram illustrating a flow of calculation processing (A);

FIG. 24 is a diagram illustrating a flow of calculation processing (B);

FIG. 25 is a diagram illustrating an example of teacher data according to a second embodiment;

FIG. 26 is a diagram illustrating an example of a meaning vector database according to the second embodiment;

FIG. 27 is a diagram illustrating an example of a voice notation database according to the second embodiment;

FIG. 28 is a diagram illustrating a procedure for calculating parameters relating to meaning according to the second embodiment;

FIG. 29 is a diagram illustrating a procedure for calculating parameters relating to voice according to the second embodiment;

FIG. 30 is a diagram illustrating an example of the correspondence between vowels and consonants with each element of a voice vector;

FIG. 31 is a diagram illustrating a module configuration example of a learning unit according to the second embodiment;

FIG. 32 is a diagram illustrating a learning processing flow according to the second embodiment;

FIG. 33 is a diagram illustrating an example of a third notation table;

FIG. 34 is a diagram illustrating a second feature table according to the second embodiment;

FIG. 35 is a diagram illustrating an example of a second parameter table according to the second embodiment;

FIG. 36A is a diagram illustrating a third generation processing (B) flow;

FIG. 36B is a diagram illustrating the third generation processing (B) flow;

FIG. 36C is a diagram illustrating the third generation processing (B) flow;

FIG. 37 is a diagram illustrating an evaluation processing flow according to the second embodiment;

FIG. 38A is a diagram illustrating a sixth generation processing (B) flow;

FIG. 38B is a diagram illustrating the sixth generation processing (B) flow; and

FIG. 39 is a functional block diagram of a computer.

### DESCRIPTION OF EMBODIMENTS

Interpretation of, for example, literary works, and description for private communication or advertisement depends upon sensitivity of a reader, and thus, it does not have to be logical in many cases. Hence, in a case where a character string relating to such description is intended to be evaluated, a sentence correction tool or a sentence analysis tool does not help much. The sensitivity of the reader has various aspects.

A technology disclosed in the example estimates sensitive evaluation of a reader relating to a character string, in one aspect.

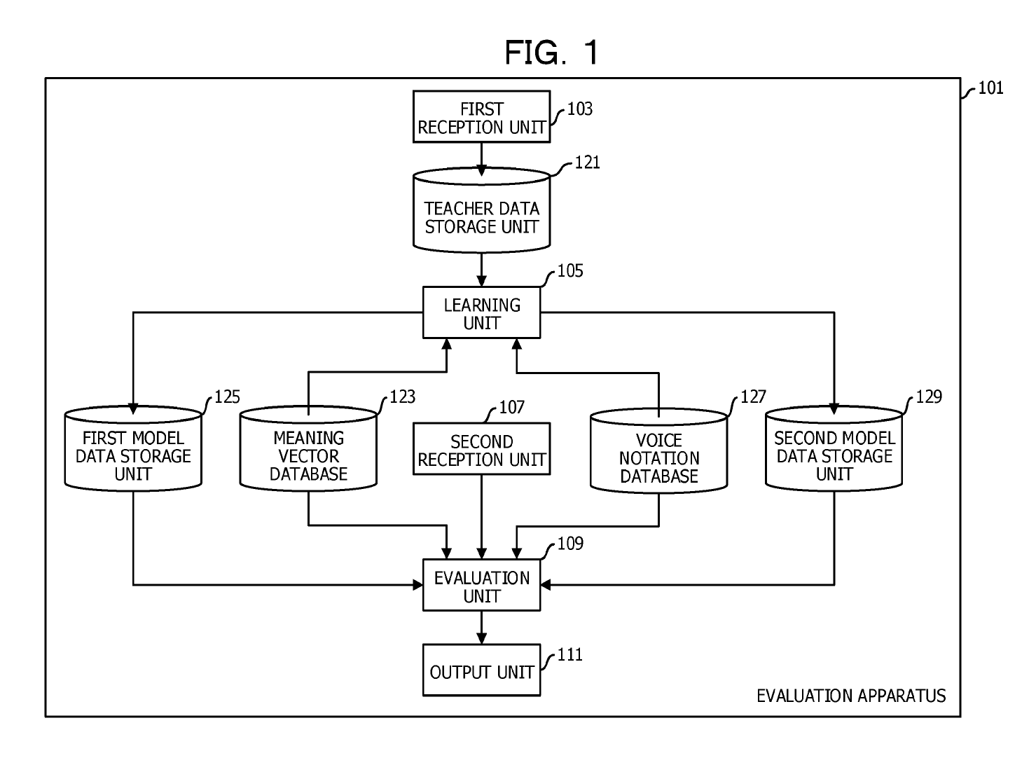

FIG. 1 illustrates a module configuration example of an evaluation apparatus 101. The evaluation apparatus 101 includes a first reception unit 103, a learning unit 105, a second reception unit 107, an evaluation unit 109, an output unit 111, a teacher data storage unit 121, a meaning vector database 123, a first model data storage unit 125, a voice notation database 127, and a second model data storage unit 129.

The first reception unit 103 receives teacher data. The learning unit 105 performs learning processing. During the learning processing, a first model relating to meaning and a second model relating to voice are generated by machine learning. The second reception unit 107 receives a character string which is evaluated. The evaluation unit 109 performs evaluation processing. During the evaluation processing, a first evaluation value relating to meaning is calculated by using the first model, and a second evaluation value relating to voice is calculated by using the second model. Furthermore, during the evaluation processing, an overall third evaluation value is calculated based on the first evaluation value and the second evaluation value. The output unit 111 outputs the third evaluation value.

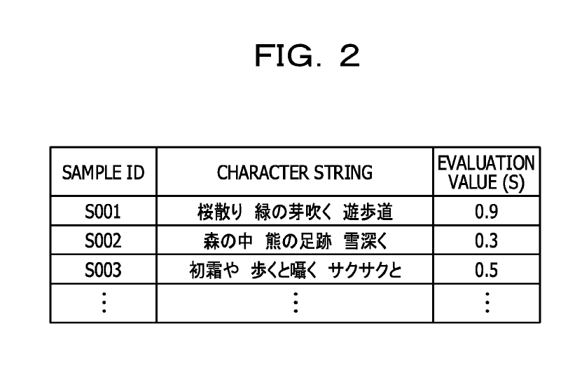

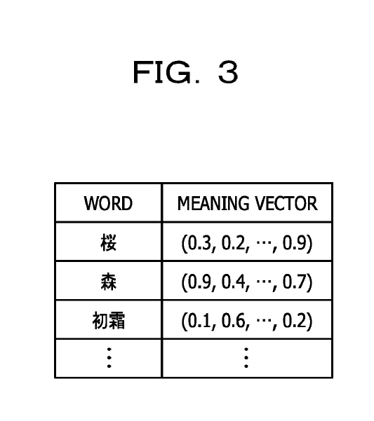

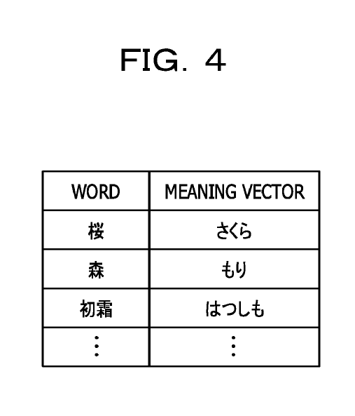

The teacher data storage unit 121 stores teacher data. The teacher data will be described below with reference to FIG. 2. The meaning vector database 123 stores meaning vectors of words. The meaning vector database 123 will be described below with reference to FIG. 3. The first model data storage unit 125 stores definition of a neural network which is used for machine learning relating to meaning and a coupling load of the neural network. The voice notation database 127 stores voice notation of words. The voice notation database 127 will be described below with reference to FIG. 4. The second model data storage unit 129 stores definition of a neural network which is used for machine learning relating to voice and a coupling load of the neural network.

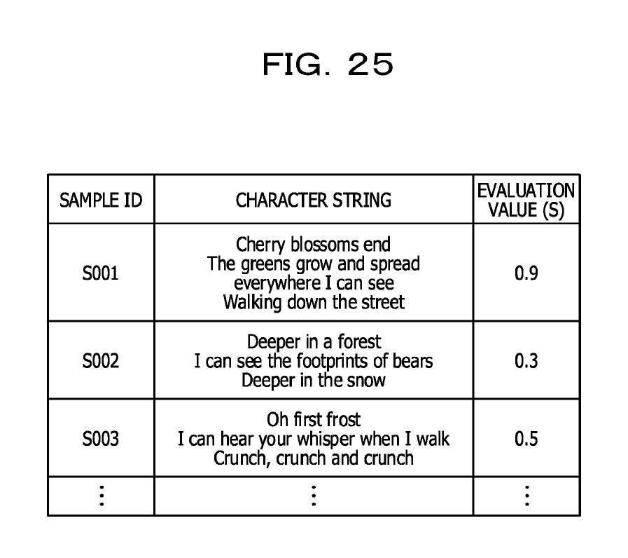

The first reception unit 103, the learning unit 105, the second reception unit 107, the evaluation unit 109, and the output unit 111 are realized by using hardware resources (for example, FIG. 25) and a program which performs the following processing by using a processor.

The teacher data storage unit 121, the meaning vector database 123, the first model data storage unit 125, the voice notation database 127, and the second model data storage unit 129 are realized by using the hardware resources (for example, FIG. 25).

FIG. 2 illustrates an example of the teacher data. The teacher data of the example has a table format. However, the teacher data may have formats other than the table format. The teacher data of the example has record corresponding to a sample. The record of the teacher data includes a field in which a sample ID is stored, a field in which the character string is stored, and a field in which evaluation value is stored.

The sample ID identifies the sample. It is assumed that a set of the character string and the evaluation value is prepared as a sample in advance. The evaluation value is a value which is obtained by evaluating the character string.

For example, the illustrated first record indicates that the evaluation value with respect to the character string “ [symbol] [symbol] ” which is identified by a sample ID “S001” is “0.9”.

FIG. 3 illustrates an example of the meaning vector database 123. In the example, a table of the meaning vector database 123 includes record corresponding to words. The record of the table of the meaning vector database 123 includes a field in which words are stored and a field in which meaning vectors are stored.

It is assumed that the meaning vector database 123 is obtained by analyzing a sentence corpus (for example, a sentence registered in a dictionary site or a social network service (SNS) site) by using a word vectoring tool (for example, Word2Vec). A word appears in the sentence corpus. The meaning vector indicates semantic feature of the word.

FIG. 4 illustrates an example of the voice notation database 127. In the example, a table of the voice notation database 127 includes record corresponding to words. The record of the table of the voice notation database 127 includes a field in which words are stored and a field in which Hiragana notation is stored.

In the Hiragana notation, reading of the word is represented by Hiragana. In this example, an example of the Hiragana notation is described, but Katakana notation may be used. In addition, a Roman notation or a phonetic symbol notation may be used. Furthermore, data indicating a waveform of sound may be stored in addition to voice notation.

For example, an illustrated first record indicates that words “ [symbol] ” are written as “ [symbol] ” in Hiragana.

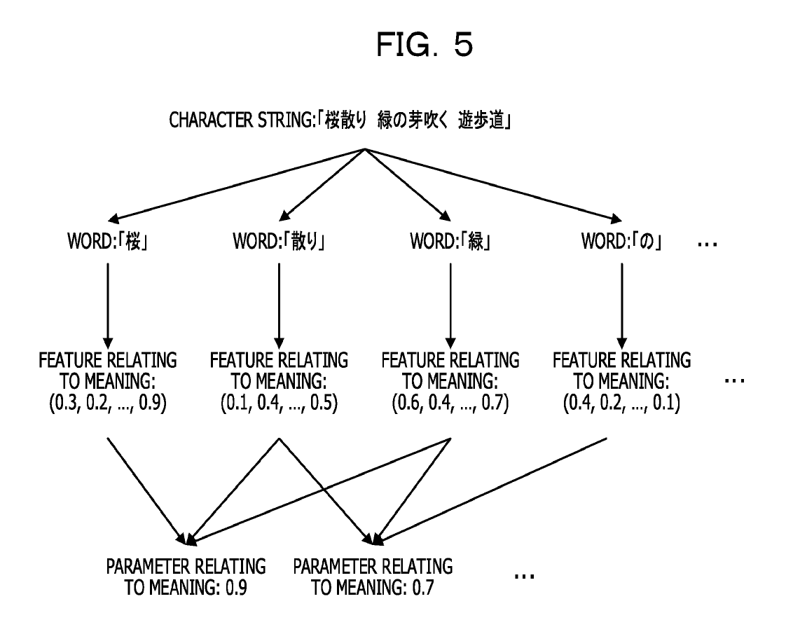

Subsequently, a procedure of calculating parameters relating to meaning will be described. The parameter is used as an input value of the neural network. FIG. 5 illustrates a procedure of calculating parameters relating to meaning. First, a character string is divided into words. In this example, the character string “ [symbol] [symbol] ” is divided into words “ [symbol] ”, “ [symbol] ”, “ [symbol] ”, “ [symbol] ”, and the like.

Next, each word is converted into meaning vectors corresponding to features relating to the words. For example, the word “ [symbol] ” is converted into meaning vectors (0.3, 0.2, . . . , 0.9). As described above, meaning vectors of each word are registered in the meaning vector database 123 which is prepared in advance.

Hence, parameters relating to meaning are obtained based on the meaning vectors. In this example, sets of three consecutive meaning vectors are sequentially specified, a maximum value of elements included in each meaning vector of each set is selected, and the selected maximum value is used as a parameter relating to meaning. In relation to a set of a first meaning vector to a third meaning vector, this example represents that a value of “0.9” which is maximum among elements included in each meaning vector becomes a first parameter relating to meaning. In addition, in relation to a set of a second meaning vector to a fourth meaning vector, this example represents that a value of “0.7” which is maximum among elements included in each meaning vector becomes a second parameter relating to meaning. Hereinafter, the same is used.

Here, an example in which the number of meaning vectors included in the set is three is described, but the number of meaning vectors included in the set may be four or more. In addition, the number of meaning vectors included in the set may be two or less. In a case where the number of meaning vector included in the set is one, a parameter relating to meaning for each word is obtained.

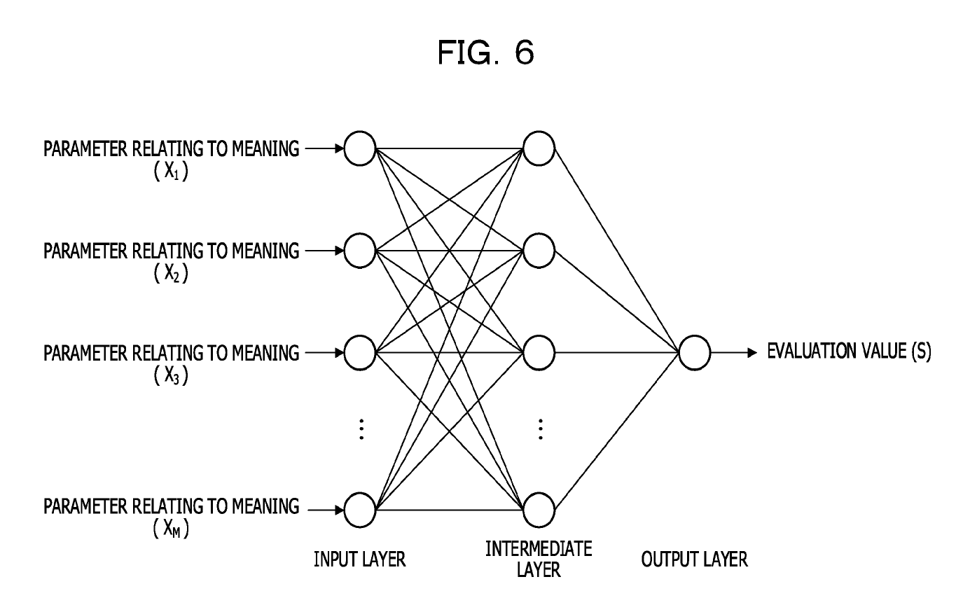

Subsequently, a configuration of the neural network which is used for machine learning relating to meaning will be described. FIG. 6 illustrates an example of the neural network which is used for the machine learning relating to meaning. The neural network of this example is a hierarchical type including an input layer, an intermediate layer, and an output layer.

Input values of the neural network are each parameter (X₁ to X_{M}) relating to meaning. Accordingly, the input layer includes units corresponding to each parameter relating to meaning. For example, input layer includes a unit corresponding to a maximum number (M) among the number of sets specified in the character strings of each sample. Meanwhile, in a case where the number of sets specified in a certain sample is smaller than the number of units, a predetermined value may be set for a part of the units, for example.

In this example, the intermediate layer includes the same number of units as the input layer. However, the number of units of the intermediate layer may not be the same as the input layer. The output layer includes one unit corresponding to an evaluation value (S) which is an output value of the neural network. Here, an example of the neural network of three layers is described, but the neural network of four layers or more may be used. In addition, a learning instrument other than the neural network may be used.

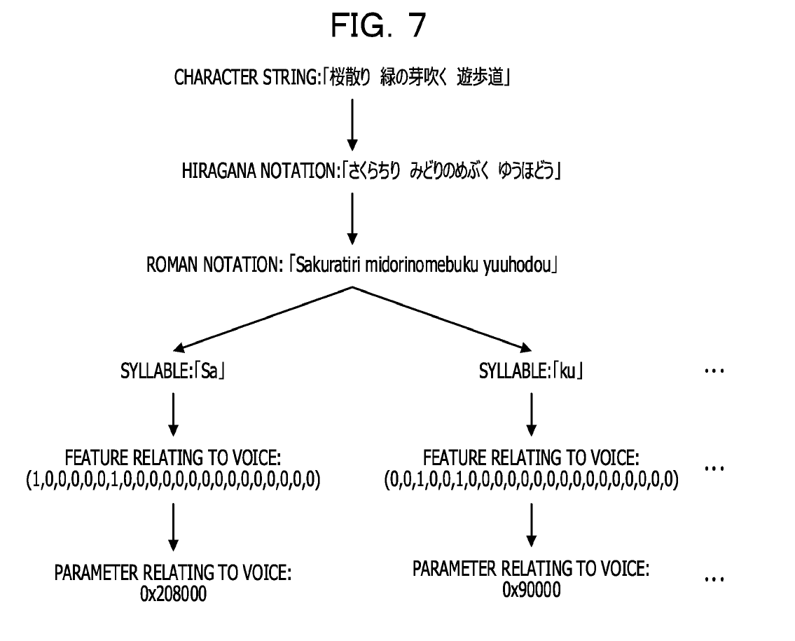

Subsequently, a procedure of calculating parameters relating to voice will be described. The parameters are used as an input value of the neural network. FIG. 7 illustrates a procedure of calculating parameter relating to voice. First, a character string is converted into a Hiragana notation. In this example, the character string “ [symbol] [symbol] ” is converted into a Hiragana notation “ [symbol] [symbol] [symbol] ”.

Next, the Hiragana notation is converted into a Roman notation. In this example, the Hiragana notation “ [symbol] [symbol] [symbol] ” is converted into a Roman notation “Sakuratiri midorinomebuku yuuhodou”. Meanwhile, the character string of the sample may be directly converted into the Roman notation.

Next, syllables are extracted from the Roman notation. In this example, syllables “Sa”, “ku”, and the like are extracted. Meanwhile, one Hiragana character may be extracted from the Hiragana notation, and the syllables may be specified by the Roman notation corresponding to the Hiragana.

Next, the extracted each syllable is converted into features relating to voice. In this example, the features relating to voice are represented by 22 dimensional voice vectors. Each element included in the voice vector corresponds to a vowel or a consonant. Hence, in a case where a syllable includes a vowel or a consonant corresponding to the element, a value of the element is “1”. Values of the other elements are “0”. In this example, each element corresponds to a vowel “a”, a vowel “i”, a vowel “u”, a vowel “e”, a consonant “o”, a consonant “k”, a consonant “s”, a consonant “t”, a consonant “n”, a consonant “h”, a consonant “m”, a consonant “y”, a consonant “r”, a consonant “w”, a consonant “nn”, a consonant “g”, a consonant “z”, a consonant “d”, a consonant “b”, a consonant “p”, a consonant “x”, and no consonant, sequentially from the first. Meanwhile, a syllabic nasal “n” is regarded as one syllable by itself, and a value of an element corresponding to a consonant “nn” is set to “1”. In addition, in a case where the syllable does not include a consonant, a value of an element corresponding to no consonant is set to “1”. For example, since the first syllable “Sa” includes a consonant “s” and a vowel “a”, the syllable is converted into a voice vector 1, 0, 0, 0, 0, 0, 1, 0, 0, 0, 0, 0, 0, 0, 0, 0, 0, 0, 0, 0, 0, 0. In the same manner, since the second syllable “ku” includes a consonant “k” and a vowel “u”, the syllable is converted into a voice vector 0, 0, 1, 0, 0, 1, 0, 0, 0, 0, 0, 0, 0, 0, 0, 0, 0, 0, 0, 0, 0, 0. Meanwhile, here, an example in which a voice vector is specified based on the Roman alphabet is described, but the voice vector may be specified based on phonetic symbols.

Hence, the voice vector relating to voice is converted into a parameter relating to voice. In this example, 22 elements included in the voice vector correspond to each digit of a binary number with 22 digits. Hence, a value of the binary number is converted into a value of a hexadecimal number. For example, in a case of voice vector (1, 0, 0, 0, 0, 0, 1, 0, 0, 0, 0, 0, 0, 0, 0, 0, 0, 0, 0, 0, 0, 0) which is the first feature relating to voice, a binary number “1000001000000000000000” is converted into a hexadecimal number “0x208000”. Hence, the hexadecimal number “0x208000” becomes a first parameter relating to voice. In the same manner, in a case of the voice vector (0, 0, 1, 0, 0, 1, 0, 0, 0, 0, 0, 0, 0, 0, 0, 0, 0, 0, 0, 0, 0, 0) which is the second feature relating to voice, a binary number “0010010000000000000000” is converted into a hexadecimal number “0x90000”. Hence, the hexadecimal number “0x90000” becomes the second parameter relating to voice.

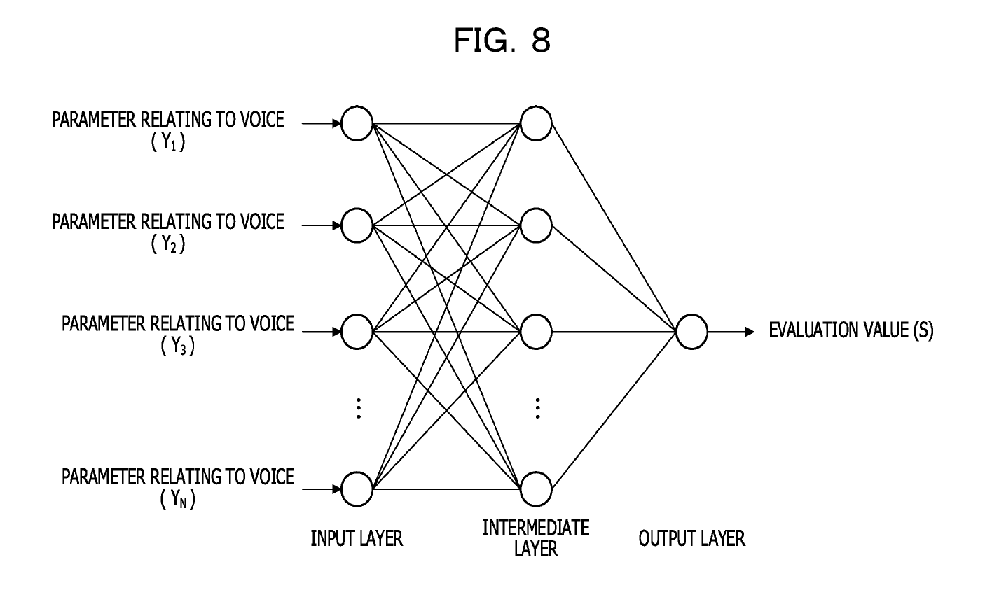

Subsequently, a configuration of the neural network which is used for machine learning relating to voice will be described. FIG. 8 is a diagram illustrating an example of the neural network which is used for the machine learning relating to voice. The neural network in this example is a hierarchical type including an input layer, an intermediate layer, and an output layer.

Input values of the neural network are each parameter (Y₁ to Y_{N}) relating to voice. Accordingly, the input layer includes units corresponding to each parameter relating to voice. For example, input layer includes a unit corresponding to a maximum number (N) among the number of syllables included in character strings of each sample. Meanwhile, in a case where the number of syllables included in the character string is smaller than the number of units, a predetermined value may be set for a part of the units, for example.

In this example, the intermediate layer includes the same number of units as the input layer. However, the number of units of the intermediate layer may not be the same as the input layer. The output layer includes one unit corresponding to the evaluation value (S) which is an output value of the neural network. Here, an example of the neural network of three layers is described, but the neural network of four layers or more may be used. In addition, a learning instrument other than the neural network may be used.

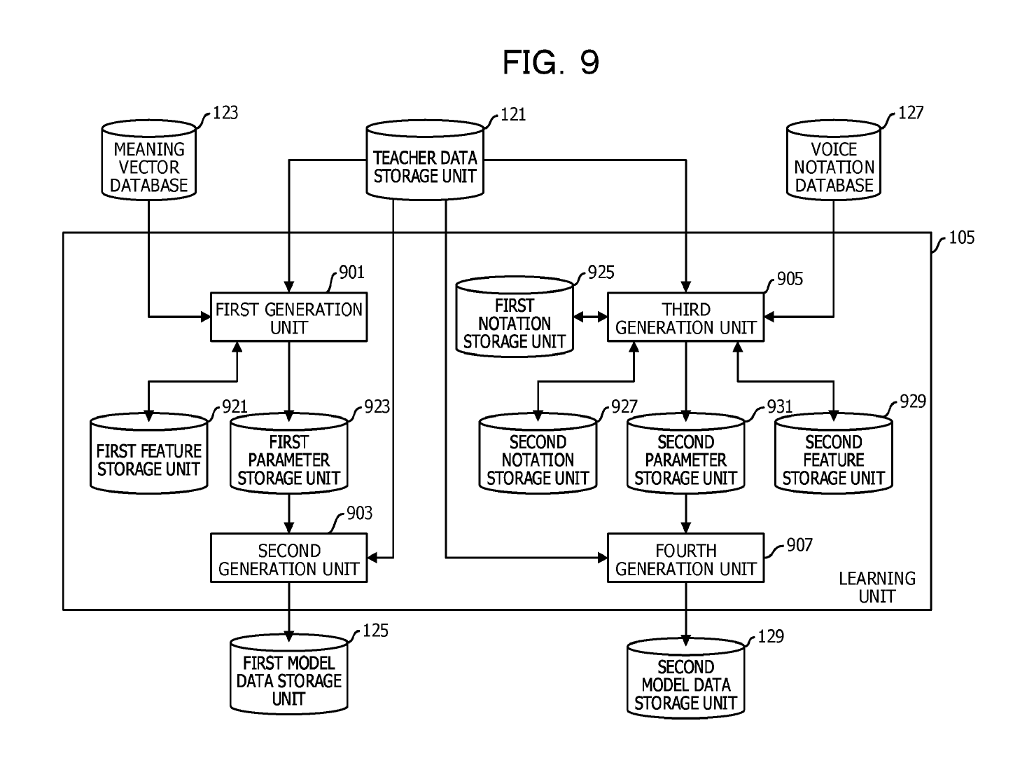

Subsequently, an operation of the learning unit 105 will be described. FIG. 9 illustrates a module configuration example of the learning unit 105. The learning unit 105 includes a first generation unit 901, a second generation unit 903, a third generation unit 905, a fourth generation unit 907, a first feature storage unit 921, a first parameter storage unit 923, a first notation storage unit 925, a second notation storage unit 927, a second feature storage unit 929, and a second parameter storage unit 931.

The first generation unit 901 performs first generation processing. In the first generation processing, a first feature table and a first parameter table are generated. The second generation unit 903 performs second generation processing. In the second processing, a first model relating to meaning is generated by machine learning which uses the neural network. The third generation unit 905 performs third generation processing. In the third generation processing, a first notation table, a second notation table, a second feature table, and a second parameter table are generated. The fourth generation unit 907 performs fourth generation processing. In the fourth generation processing, a second model relating to voice is generated by the machine learning which uses the neural network.

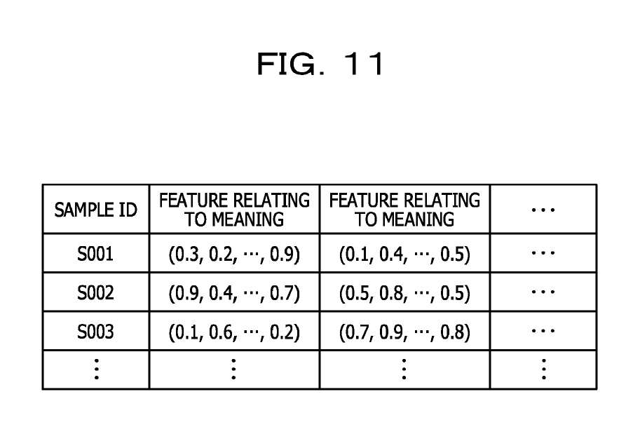

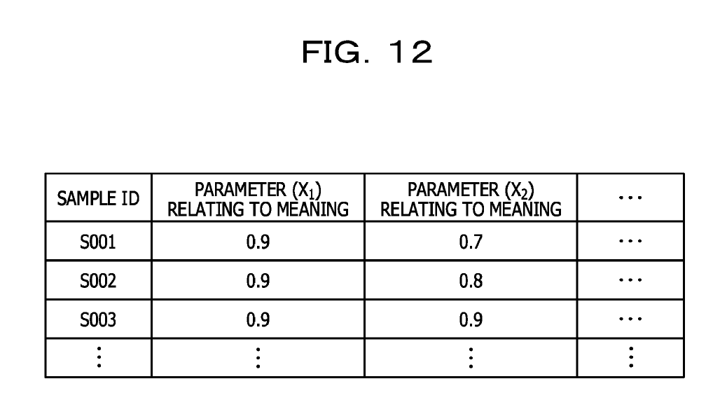

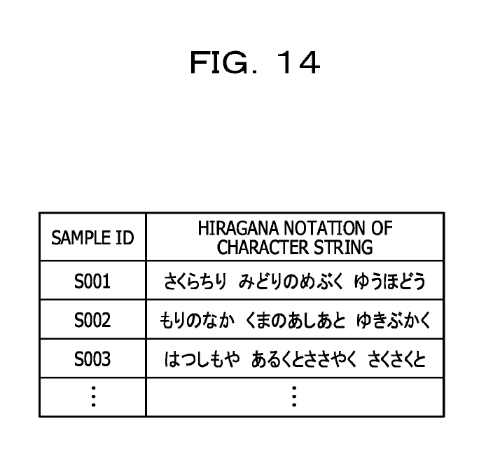

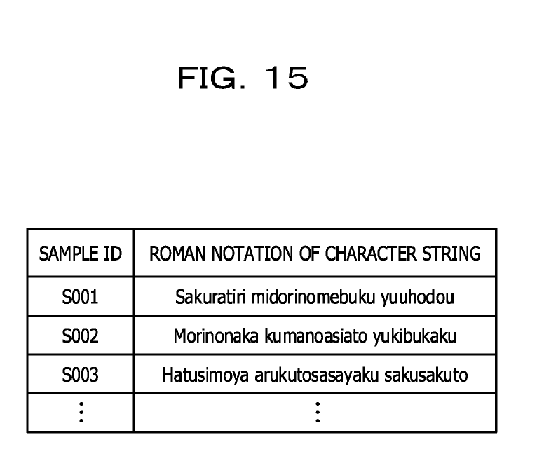

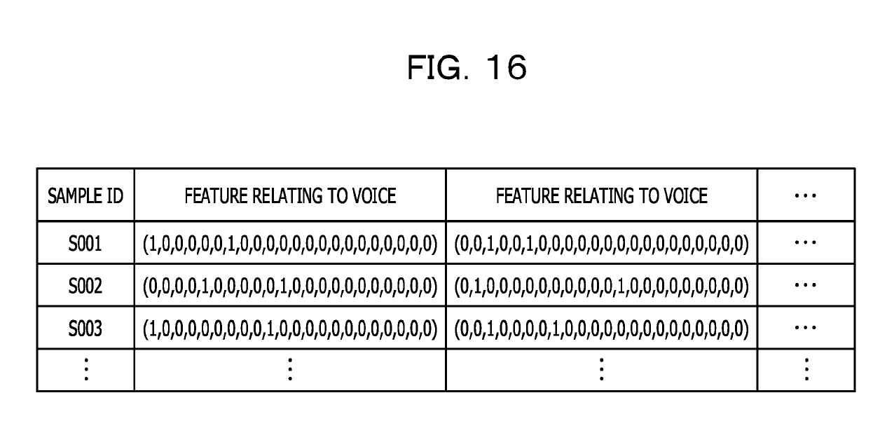

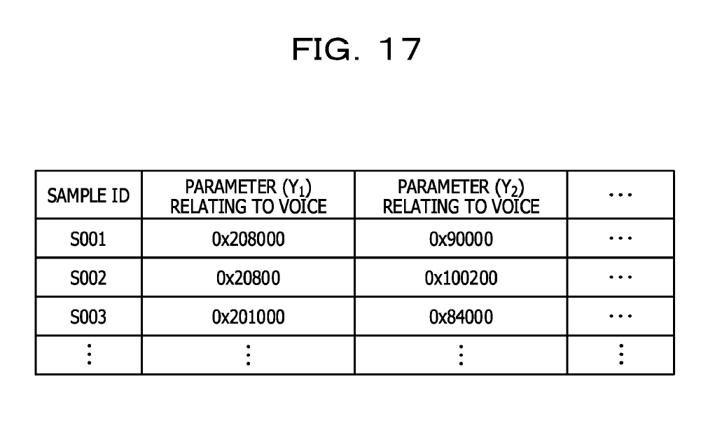

The first feature storage unit 921 stores the first feature table. The first feature table will be described below with reference to FIG. 11. The first parameter storage unit 923 stores the first parameter table. The first parameter table will be described below with reference to FIG. 12. The first notation storage unit 925 stores the first notation table. The first notation table will be described below with reference to FIG. 14. The second notation storage unit 927 stores the second notation table. The second notation table will be described below with reference to FIG. 15. The second feature storage unit 929 stores the second feature table. The second feature table will be described below with reference to FIG. 16. The second parameter storage unit 931 stores the second parameter table. The second parameter table will be described below with reference to FIG. 17.

The first generation unit 901, the second generation unit 903, the third generation unit 905, and the fourth generation unit 907 are realized by using the hardware resources (for example, FIG. 25) and a program which performs the following processing by using a processor.

The first feature storage unit 921, the first parameter storage unit 923, the first notation storage unit 925, the second notation storage unit 927, the second feature storage unit 929, and the second parameter storage unit 931 are realized by using the hardware resources (for example, FIG. 25).

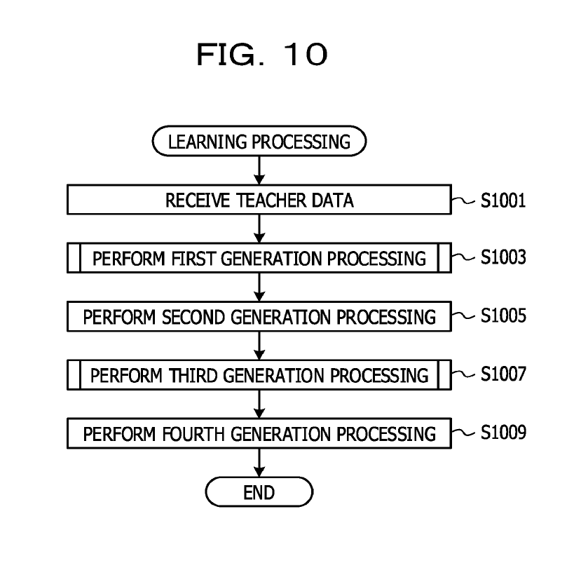

Hereinafter, learning processing of the learning unit 105 will be described. FIG. 10 illustrates a learning processing flow. The first reception unit 103 receives teacher data (S1001). The received teacher data is stored in the teacher data storage unit 121. Meanwhile, the evaluation apparatus 101 may generate the teacher data.

The first generation unit 901 performs first generation processing (S1003). Before the first generation processing is described, the first feature table and the first parameter table which are generated in the first generation processing will be described.

FIG. 11 illustrates an example of the first feature table. The first feature table of this example includes record corresponding to a sample. The record of the first feature table includes a field in which a sample ID is stored, and a plurality of fields in which features relating to meaning is stored.

The sample ID identifies the sample. The features relating to meaning are features relating to meaning of each word included in a character string of the sample. Hence, fields corresponding to the number of words included in the character string of the sample are included. In this example, the features relating to meaning is meaning vectors. However, the features relating to meaning may be vectors other than the meaning vectors.

For example, the illustrated first record indicates that features of words, which appear first, of a character string which is identified by a sample ID “5001” are represented by meaning vectors (0.3, 0.2, . . . , 0.9) and in the same manner, features of words which appear second are represented by meaning vectors (0.1, 0.4, . . . , 0.5).

FIG. 12 illustrates an example of a first parameter table. The first parameter table according to this example includes record corresponding to a sample. The record of the first parameter table includes a field in which a sample ID is stored, and a plurality of fields in which parameter relating to meaning is stored.

The sample ID identifies the sample. The parameters relating to meaning are parameters based on the features relating to meaning of words included in the character string of the sample, as described with reference to FIG. 5.

For example, the illustrated first record indicates that the first parameter based on the features relating to meaning of the words included in the character string which is identified by the sample ID “S001” is “0.9” and in the same manner, the second parameter is “0.7”. Meanwhile, in a case where the feature relating to meaning is a one-dimensional variable, the feature relating to meaning may be used as the parameter relating to meaning as it is.

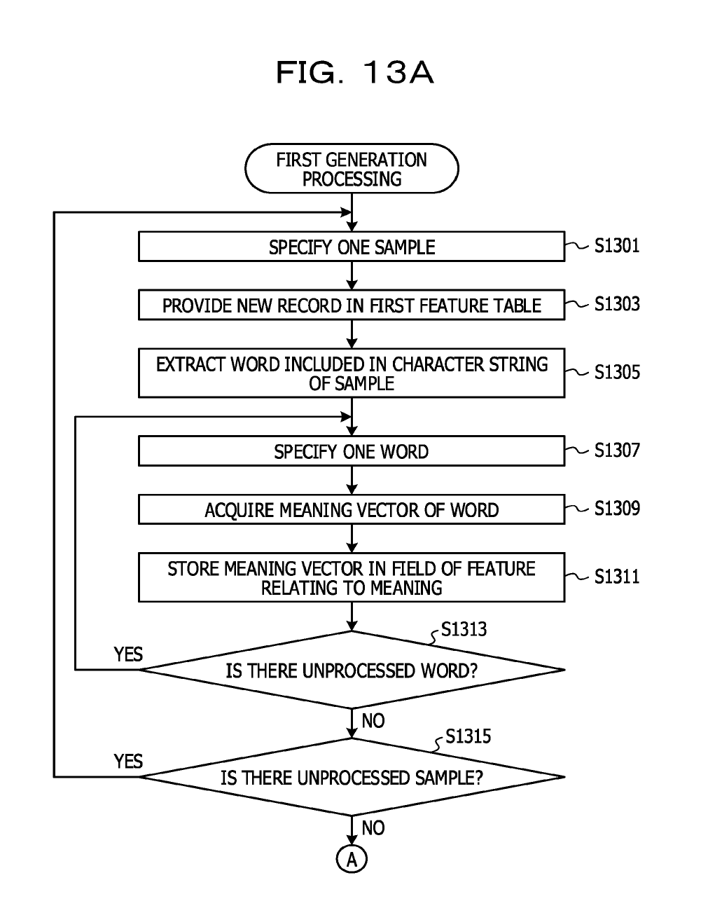

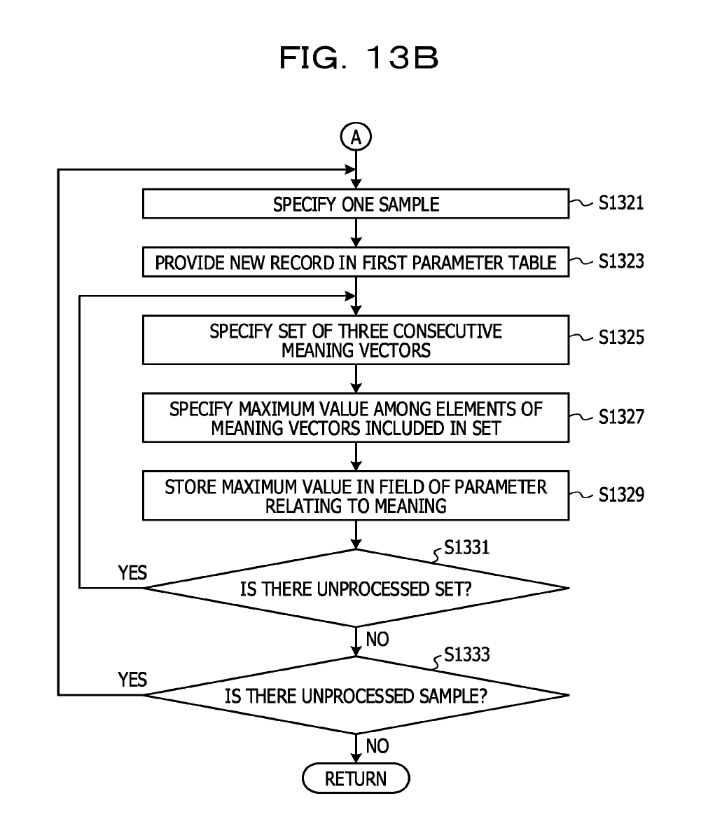

Subsequently, the first generation processing will be described. FIG. 13A illustrates a first generation processing flow. The first generation unit 901 specifies one sample (S1301). For example, the first generation unit 901 specifies sample ISs in an ascending order.

The first generation unit 901 provides new record to the first feature table (S1303). A sample ID which is specified in S1301 is stored in the new record.

The first generation unit 901 extracts words included in a character string of a sample (S1305). For example, the first generation unit 901 performs morphological analysis thereby dividing the character string into a plurality of words.

The first generation unit 901 specifies one word which is extracted (S1307). Specifically, the first generation unit 901 sequentially specifies the divided words from the head.

The first generation unit 901 acquires meaning vectors of the words from the meaning vector database 123 (S1309). Hence, the first generation unit 901 sequentially stores the meaning vectors in the field of the feature relating to meaning in the record provided in S1303 (S1311).

The first generation unit 901 determines whether or not there is an unprocessed word among the words extracted in S1305 (S1313). In a case where it is determined that there is an unprocessed word, the flow returns to the processing illustrated in S1307 and repeats the aforementioned processing.

Meanwhile, in a case where it is determined that there is no unprocessed word, the first generation unit 901 determines whether or not there is an unprocessed sample (S1315). In a case where it is determined that there is an unprocessed sample, the flow returns to the processing illustrated in S1301 and repeats the aforementioned processing.

Meanwhile, in a case where it is determined that there is no unprocessed sample, the flow proceeds to processing of S1321 illustrated in FIG. 13B through a terminal A. 13B. At a point of time when it is determined that there is no unprocessed sample, generation of the first feature table is completed.

Description of FIG. 13B will be made again. In the following processing, the first parameter table is generated. The first generation unit 901 specifies one sample (S1321). For example, the first generation unit 901 specifies sample IDs in ascending order.

The first generation unit 901 provides new record to the first parameter table (S1323). The sample ID specified in S1321 is stored in the new record.

The first generation unit 901 specifies a set of three consecutive meaning vectors (S1325). Firstly, meaning vectors which are set in the first to third fields among a plurality of fields in which features relating to meaning are stored are specified in the record of the first feature table. Secondly, meaning vectors set in the second to fourth fields are specified. Thereafter, sequential shifting of the fields is performed to specify three meaning vectors.

The first generation unit 901 specifies a maximum value among the elements of the meaning vectors included in the set (S1327). Hence, the first generation unit 901 stores the maximum value in the field of the parameters relating to meaning (S1329).

The first generation unit 901 determines whether or not there is an unprocessed set (S1331). In a case where it is determined that there is an unprocessed set, the flow returns to the processing illustrated in S1325 and repeats the aforementioned processing. Meanwhile, the number of sets specified by the repeated processing in this example is the number of words, which are included in the character string, minus 2.

Meanwhile, in a case where it is determined that there is no unprocessed set, the first generation unit 901 determines whether or not there is an unprocessed sample (S1333). In a case where it is determined that there is an unprocessed sample, the flow returns to the processing illustrated in S1321 and repeats the aforementioned processing.

Meanwhile, in a case where it is determined that there is no unprocessed sample, the first generation processing ends. At a point of time when it is determined that there is no unprocessed sample, generation of the first parameter table is completed. If the first generation processing ends, the flow returns to the learning processing of a caller.

Description of FIG. 10 will be made again. The second generation unit 903 performs the second generation processing (S1005). In the second generation processing, each parameter relating to meaning is set to units of the input layer of the neural network illustrated in FIG. 6, an evaluation value is set to units of the output layer of the neural network, and the machine learning is performed by an error back propagation method. Hence, a coupling load obtained by the machine learning is stored in the first model data storage unit 125.

The third generation unit 905 performs the third generation processing (S1007). Before the third generation processing is described, the first notation table, the second notation table, the second feature table, and the second parameter table which are generated by the third generation processing will be described.

FIG. 14 illustrates an example of the first notation table. The first notation table according to this example includes record corresponding to a sample. The record of the first notation table includes a field in which a sample ID is stored and a field in which Hiragana notation of a character string is stored.

The sample ID identifies the sample. The Hiragana notation of the character string represents reading of the character string of the sample by using Hiragana.

For example, the illustrated first record indicates that reading of the character string of the first sample is represented by Hiragana [symbol] [symbol] [symbol] .

FIG. 15 illustrates an example of the second notation table. The second notation table according to this example includes record corresponding to a sample. The record of the second notation table includes a field in which sample IDs are stored and a field in which Roman notation of a character string is stored.

The sample ID identifies the sample. The Roman notation of the character string represents reading of the character string of the sample by using Roman alphabets.

For example, the illustrated first record indicates that reading of the character string of the first sample is represented by Roman notation “Sakuratiri midorinomebuku yuuhodou”.

FIG. 16 illustrates an example of the second feature table. The second feature table includes record corresponding to a sample. The record of the second feature table includes a field in which sample IDs are stored and a plurality of fields in which features relating to voice are stored.

The sample ID identifies a sample. The features relating to voice are features relating to voice of each syllable included in a character string of the sample. Hence, fields corresponding to the number of syllables included in the character string of the sample are provided. In this example, the features relating to voice are voice vectors. However, the features relating to voice may be vectors other than the voice vectors.

For example, the illustrated first record indicates that a first syllable of the first sample is represented by a voice vector (1, 0, 0, 0, 0, 0, 1, 0, 0, 0, 0, 0, 0, 0, 0, 0, 0, 0, 0, 0, 0, 0), and in the same manner the second syllable is represented by a voice vector (0, 0, 1, 0, 0, 1, 0, 0, 0, 0, 0, 0, 0, 0, 0, 0, 0, 0, 0, 0, 0, 0).

FIG. 17 illustrates an example of the second parameter table. The second parameter table according to this example includes record corresponding to a sample. The record of the second parameter table includes a field in which sample IDs are stored and a plurality of fields in which parameters relating to voice are stored.

The sample ID identifies a sample. The parameters relating to voice are obtained for each syllable included in the character string of the sample, as described with reference to FIG. 7.

For example, the illustrated first record indicates that the parameter based on the feature of the first syllable included in the character string which is identified by a sample ID “S001” is a hexadecimal number “0x208000” and in the same manner the parameter based on the feature of the second syllable is a hexadecimal number “0x90000”. Meanwhile, in a case where the feature relating to voice is a one-dimensional variable, the feature relating to voice may be used as the parameter relating to voice as it is.

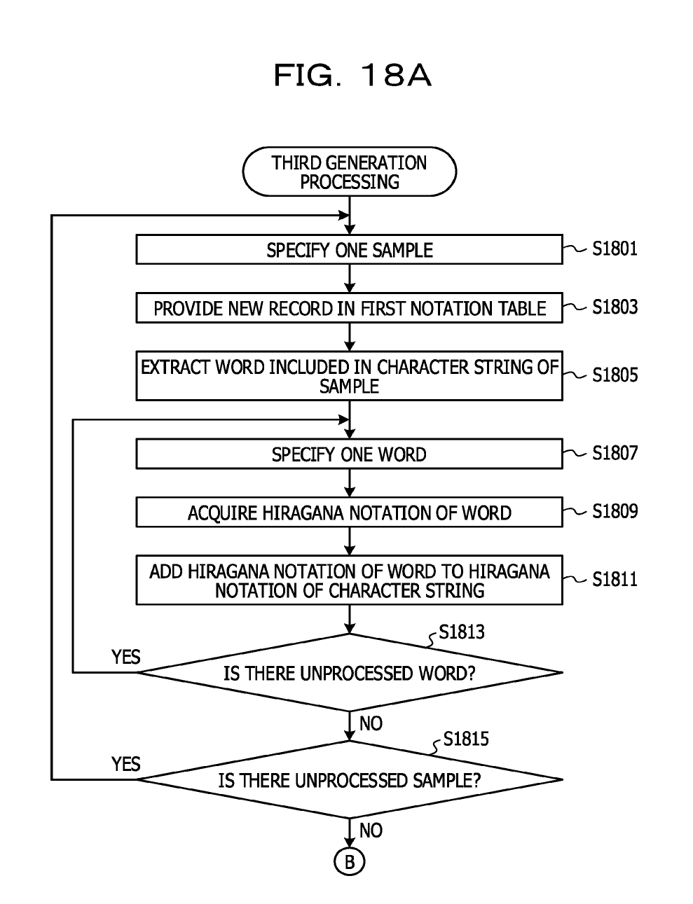

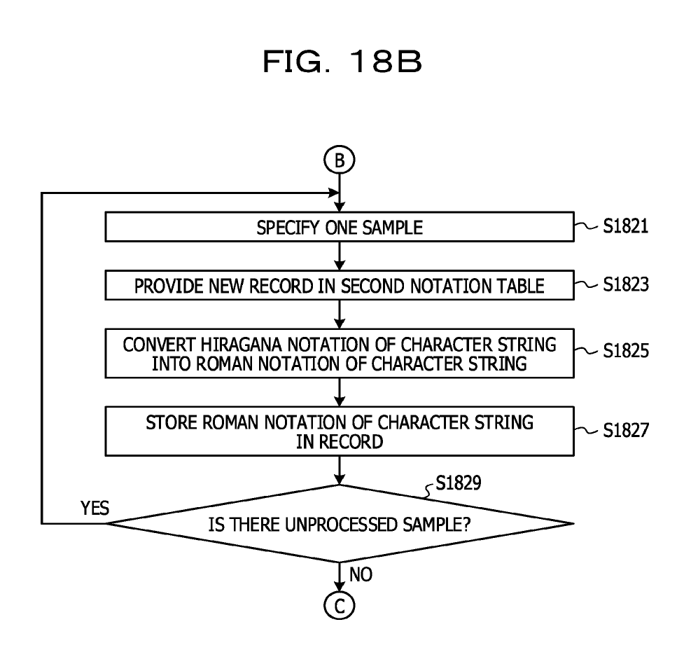

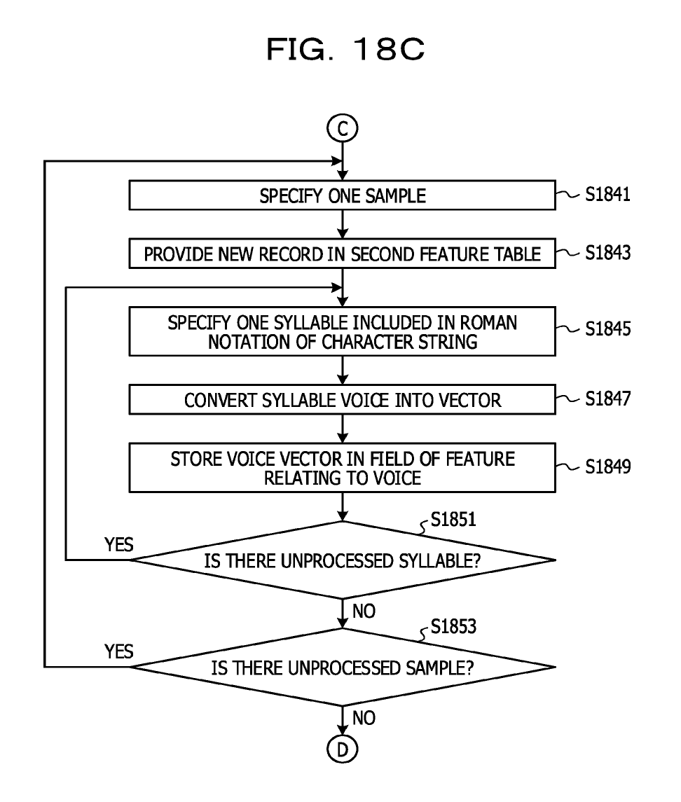

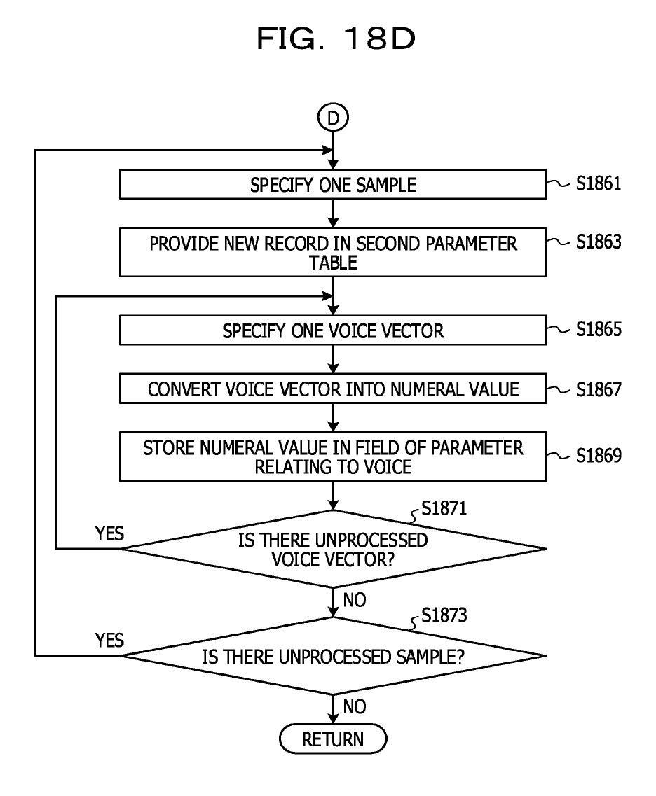

Subsequently, the third generation processing will be described. FIG. 18A illustrates a third generation processing flow. The third generation unit 905 specifies one sample (S1801). For example, the third generation unit 905 specifies sample IDs in an ascending order.

The third generation unit 905 provides new record to the first notation table (S1803). The sample ID which is specified in S1801 is stored in the new record.

The third generation unit 905 extracts words included in a character string of a sample (S1805). For example, the third generation unit 905 performs morphological analysis thereby dividing the character string into a plurality of words.

The third generation unit 905 specifies one word which is extracted (S1807). Specifically, the first generation unit 901 sequentially specifies the divided words from the head.

The third generation unit 905 acquires Hiragana notation of the words from the voice notation database 127 (S1809). Hence, the third generation unit 905 adds the Hiragana notation of the words to the field of the Hiragana notation of the character string provided in S1803 (S1811).

The third generation unit 905 determines whether or not there is an unprocessed word among the words extracted in S1805 (S1813). In a case where it is determined that there is an unprocessed word, the flow returns to the processing illustrated in S1807, and repeats the aforementioned processing.

Meanwhile, in a case where it is determined that there is no unprocessed word, the third generation unit 905 determines whether or not there is an unprocessed sample (S1815). In a case where it is determined that there is an unprocessed sample, the flow returns to the processing illustrated in S1801, and repeats the aforementioned processing.

Meanwhile, in a case where it is determined that there is no unprocessed sample, the flow proceeds to processing of S1821 illustrated in FIG. 18B through a terminal B. At a point of time when it is determined that there is no unprocessed sample, generation of the first notation table is completed.

Description of FIG. 18B will be made again. In the following processing, the second notation table is generated. The third generation unit 905 specifies one sample (S1821). For example, the third generation unit 905 specifies sample IDs in ascending order.

The third generation unit 905 provides new record to the second notation table (S1823). The sample ID specified in S1821 is stored in the new record.

The third generation unit 905 converts the Hiragana notation of the character string of the sample into Roman notation of the character string (S1825). The third generation unit 905 stores the Roman notation of the character string in the record provided in S1823 (S1827).

The third generation unit 905 determines whether or not there is an unprocessed sample (S1829). In a case where it is determined that there is an unprocessed sample, the flow returns to the processing illustrated in S1821 and repeats the aforementioned processing.

Meanwhile, in a case where it is determined that there is no unprocessed sample, the flow proceeds to processing of S1841 illustrated in FIG. 18C through a terminal C. At a point of time when it is determined that there is no unprocessed sample, generation of the second notation table is completed.

Description of FIG. 18C will be made again. In the following processing, the second feature table is generated. The third generation unit 905 specifies one sample (S1841). The third generation unit 905 specifies sample IDs in an ascending order.

The third generation unit 905 provides new record to the second feature table (S1843). The sample IDs specified in S1841 are stored in the new record.

The third generation unit 905 specifies one syllable included in the Roman notation of the character string (S1845). In this example, the third generation unit 905 sequentially specifies the syllables from front to back. The syllable is only one vowel or a combination of one vowel and one consonant.

The third generation unit 905 converts the syllable into a voice vector (S1847). A value of an element corresponding to a vowel included in the syllable is set to “1”. In addition, in a case where the syllable is a consonant, a value of an element corresponding to the consonant is set to “1”. Values of the other elements are set to “0”. Meanwhile, a syllabic nasal “n” is treated as one unit by itself, and a value of an element corresponding to a consonant “nn” is “1”.

The third generation unit 905 sequentially stores the voice vectors in the field of the feature relating to voice in the record provided in S1843 (S1849).

The third generation unit 905 determines whether or not there is an unprocessed syllable (S1851). In a case where it is determined that there is an unprocessed syllable, the flow returns to the processing illustrated in S1845 and repeats the aforementioned processing.

Meanwhile, in a case where it is determined that there is no unprocessed syllable, the third generation unit 905 determines whether or not there is an unprocessed sample (S1853). In a case where it is determined that there is an unprocessed sample, the flow returns to the processing illustrated in S1841 and repeats the aforementioned processing.

Meanwhile, in a case where it is determined that there is no unprocessed sample, the flow proceeds to the processing of S1861 illustrated in FIG. 18D through a terminal D. At a point of time when it is determined that there is no unprocessed sample, generation of the second feature table is completed.

Description of FIG. 18D will be made again. In the following processing, the second parameter table is generated. The third generation unit 905 specified one sample (S1861). For example, the third generation unit 905 specifies the sample IDs in an ascending order.

The third generation unit 905 provides new record in the second parameter table (S1863). The sample ID specified in S1861 is stored in the new record.

The third generation unit 905 specifies one voice vector stored in the field of the feature relating to voice in the record of the sample in the second feature table (S1865). Specifically, the third generation unit 905 sequentially specifies the fields of the feature relating to voice from front to back, and reads the vector stored in the field.

The third generation unit 905 converts the voice vector into a numeral value (S1867). As described above, the third generation unit 905 converts binary values of 22 digits which are obtained by respectively associating 22 elements included in the voice vector with each digit of a binary number into a hexadecimal number.

The third generation unit 905 sequentially stores the numeral values in the field of the parameter relating to voice provided in S1863 (S1869).

The third generation unit 905 determines whether or not there is an unprocessed voice vector (S1871). In a case where it is determined that there is an unprocessed voice vector, the flow returns to the processing illustrated in S1865 and repeats the aforementioned processing.

Meanwhile, in a case where it is determined that there is no unprocessed voice vector, the third generation unit 905 determines whether or not there is an unprocessed sample (S1873). In a case where it is determined that there is an unprocessed sample, the flow returns to the processing illustrated in S1861 and repeats the aforementioned processing.

Meanwhile, in a case where it is determined that there is no unprocessed sample, the third generation processing ends. At a point of time when it is determined that there is no unprocessed sample, generation of the second parameter table is completed. If the third generation processing ends, the flow returns to the learning processing of a caller.

Description of FIG. 10 will be made again. The fourth generation unit 907 performs the fourth generation processing (S1009). In the fourth generation processing, each parameter relating to voice is set in a unit corresponding to an input layer of the neural network illustrated in FIG. 8, an evaluation value is set in a unit of an output layer of the same neural network, and the machine learning is performed by an error back propagation method. Hence, a coupling load obtained by the machine learning is stored in the second model data storage unit 129. Here, description on the operation of the learning unit 105 ends.

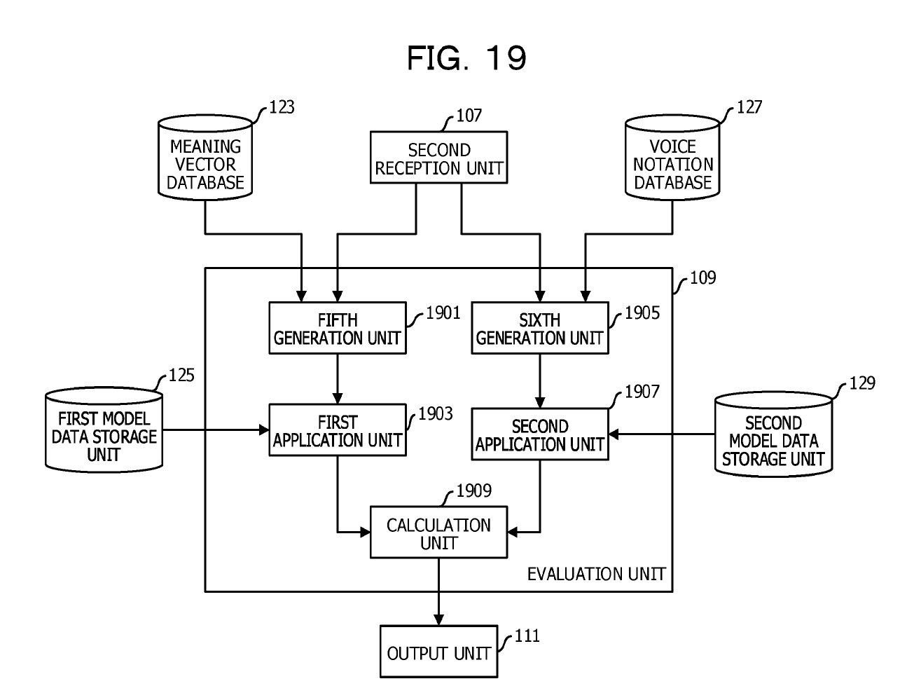

Subsequently, an operation of the evaluation unit 109 will be described. FIG. 19 illustrates a module configuration example of the evaluation unit 109. The evaluation unit 109 includes a fifth generation unit 1901, a first application unit 1903, a sixth generation unit 1905, a second application unit 1907, and a calculation unit 1909.

The fifth generation unit 1901 performs fifth generation processing. In the fifth generation processing, parameters relating to meaning are generated based on features relating to meaning of each word included in a character string which is evaluated. The first application unit 1903 performs a first application processing. In the first application processing, the parameters relating to meaning are applied to a first model, and a first evaluation value relating to meaning is estimated. The sixth generation unit 1905 performs sixth generation processing. In the sixth generation processing, parameters relating to voice are generated based on features relating to voice of each syllable included in a character string which is evaluated. The second application unit 1907 performs a second application processing. In the second application processing, the parameters relating to voice are applied to a second model, and a second evaluation value relating to voice are estimated. The calculation unit 1909 calculates an overall third evaluation value, based on the first evaluation value and the second evaluation value.

The fifth generation unit 1901, the first application unit 1903, the sixth generation unit 1905, the second application unit 1907, and the calculation unit 1909 are realized by using the hardware resources (for example, FIG. 25) and a program which performs the following processing by using a processor.

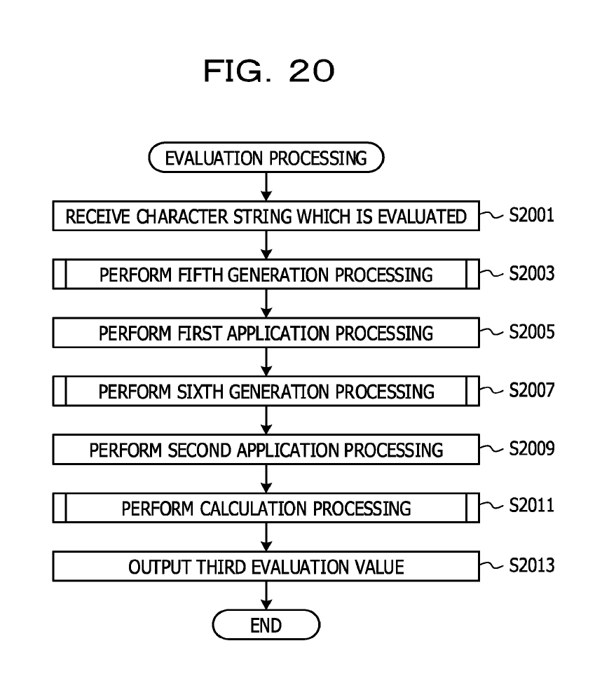

FIG. 20 illustrates an evaluation processing flow. The second reception unit 107 receives a character string which is evaluated (S2001). The received character string is retained as an internal parameter.

The fifth generation unit 1901 performs the fifth generation processing (S2003). In the fifth generation processing, a parameter based on the character string which is evaluated is generated by using the same procedure as in a case of the first generation processing of the learning processing.

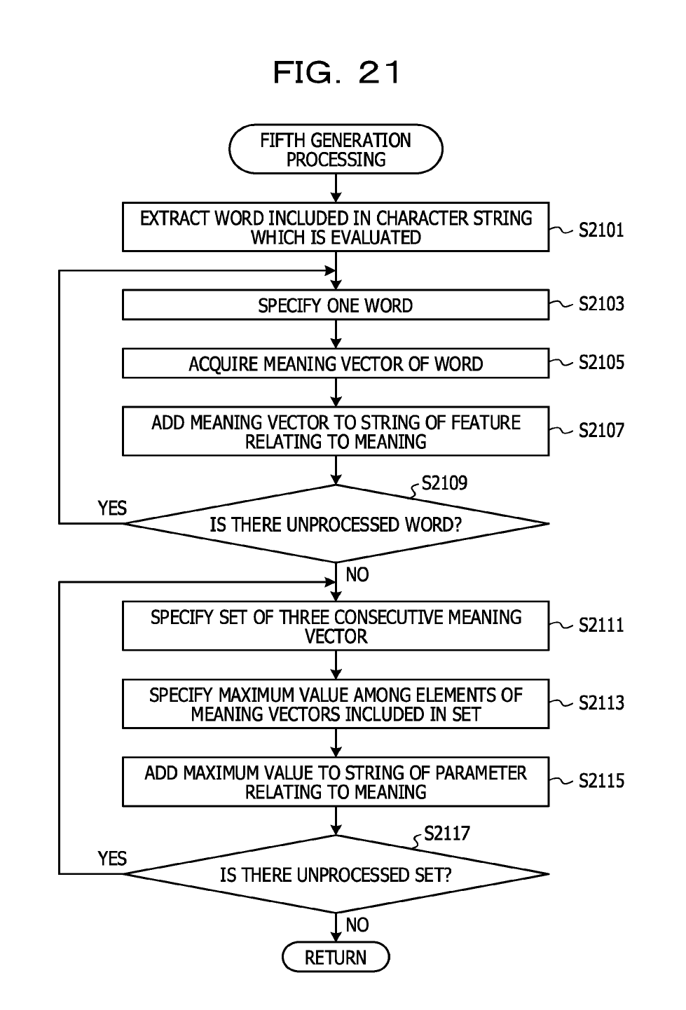

FIG. 21 illustrates the fifth generation processing flow. The fifth generation unit 1901 extracts words included in the character string which is evaluated (S2101). For example, the fifth generation unit 1901 performs morphological analysis thereby dividing the character string into a plurality of words.

The fifth generation unit 1901 specifies one word (S2103). For example, the fifth generation unit 1901 sequentially specifies the divided words from the head.

The fifth generation unit 1901 acquires a meaning vector of the word from the meaning vector database 123 (S2105). Hence, the fifth generation unit 1901 adds the acquired meaning vector to a string of the feature relating to meaning (S2107). The string of the feature relating to meaning is retained as an internal parameter, specifically in the string of the meaning vector.

The fifth generation unit 1901 determines whether or not there is an unprocessed word (S2109). In a case where it is determined that there is an unprocessed word, the flow returns to the processing illustrated in S2103 and repeats the aforementioned processing.

Meanwhile, in a case where it is determined that there is no unprocessed word, the fifth generation unit 1901 specifies a set of three consecutive meaning vectors in the string of the feature relating to meaning (S2111). Firstly, first to third meaning vectors are specified. Secondly, second to fourth meaning vector are specified. Even thereafter, sequential shifting is performed to specify three meaning vectors.

The fifth generation unit 1901 specifies a maximum value among elements of the meaning vectors included in the set (S2113). Hence, the fifth generation unit 1901 adds the maximum value to the string of the parameters relating to meaning (S2115). The string of the parameters relating to meaning is retained as internal parameters.

The fifth generation unit 1901 determines whether or not there is an unprocessed set (S2117). In a case where it is determined that there is an unprocessed set, the flow returns to the processing illustrated in S2111 and repeats the aforementioned processing.

Meanwhile, in a case where it is determined that there is no unprocessed set, the fifth generation processing ends. If the fifth generation processing ends, the flow returns to an evaluation processing of a caller.

Description of FIG. 20 will be made again. The first application unit 1903 performs the first application processing (S2005). In the first application processing, the first application unit 1903 applies each parameter relating to meaning generated in the fifth generation processing to a first model generated in the learning processing. Specifically, the first application unit 1903 sets each parameter relating to meaning to a unit corresponding to the input layer of the neural network illustrated in FIG. 6. Furthermore, the first application unit 1903 operates the neural network by using a coupling load stored in the first model data storage unit 125. As a result, the first evaluation value relating to meaning is output from a unit of the output layer.

The sixth generation unit 1905 performs the sixth generation processing (S2007). In the sixth generation processing, parameters relating to voice are generated based on the features relating to voice of each syllable included in the character string which is evaluated. The parameters are generated by the same procedure as in a case of the third generation processing of the learning processing.

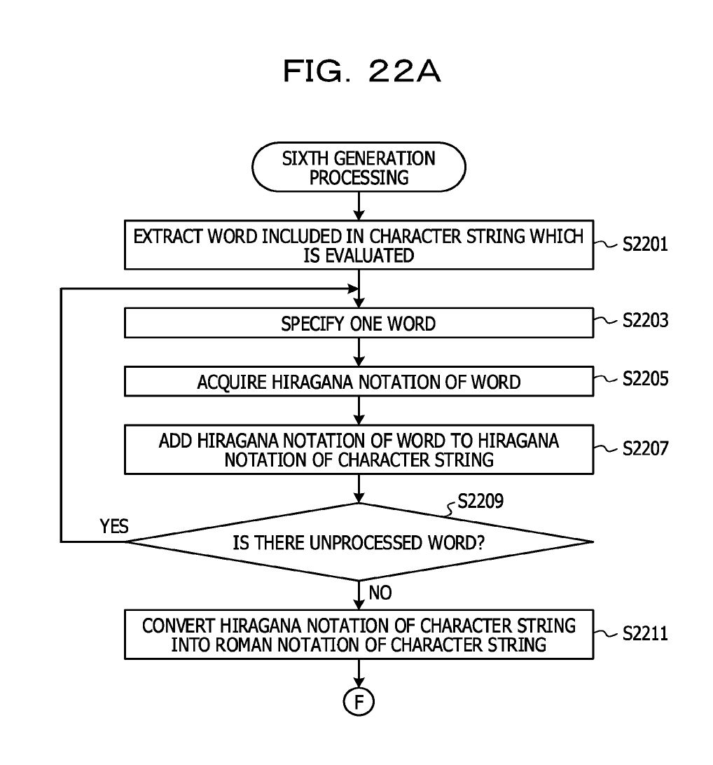

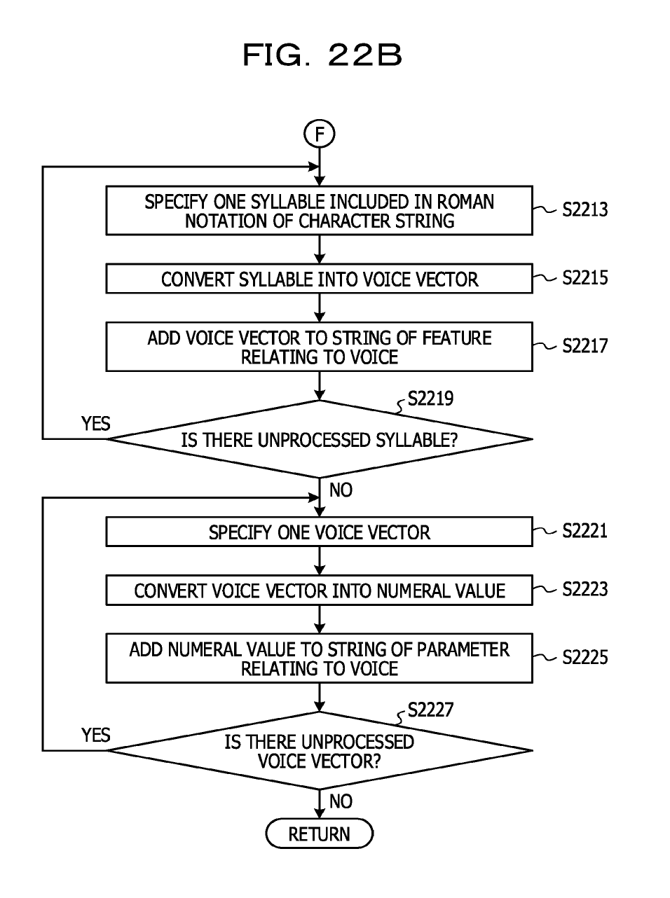

FIG. 22A illustrates the sixth generation processing flow. The sixth generation unit 1905 extracts words included in a character string which is evaluated (S2201). For example, the sixth generation unit 1905 performs morphological analysis thereby dividing the character string into a plurality of words.

The sixth generation unit 1905 specifies one word (S2203). For example, the sixth generation unit 1905 sequentially specifies the divided words from the head.

The sixth generation unit 1905 acquires Hiragana notation of the words from the voice notation database 127 (S2205). The sixth generation unit 1905 adds the Hiragana notation of the words to the Hiragana notation of the character string (S2207). The Hiragana notation of the character string is retained as an internal parameter.

The sixth generation unit 1905 determines whether or not there is an unprocessed word (S2209). In a case where it is determined that there is an unprocessed word, the flow returns to the processing illustrated in S2203 and repeats the aforementioned processing.

In a case where it is determined that there is no unprocessed word, the sixth generation unit 1905 converts the Hiragana notation of the character string into the Roman notation of the character string (S2211). The Roman notation of the character string is retained as an internal parameter. Hence, the flow proceeds to processing of S2213 illustrated in FIG. 22B through the terminal F.

Description of FIG. 22B will be made again. The sixth generation unit 1905 specifies one syllable included in Roman notation of a character string (S2213). In this example, the sixth generation unit 1905 sequentially specifies the syllables from front to back.

The sixth generation unit 1905 converts the syllable into voice vectors in the same manner as in a case of the third generation processing (S2215). The sixth generation unit 1905 adds the voice vectors to a string of the feature relating to voice (S2217). The string of the feature relating to voice is specifically a string of voice vectors and is retained as an internal parameter.

The sixth generation unit 1905 determines whether or not there is an unprocessed syllable (S2219). In a case where it is determined that there is an unprocessed syllable, the flow returns to the processing illustrated in S2213 and repeats the aforementioned processing.

Meanwhile, in a case where it is determined that there is no unprocessed syllable, the sixth generation unit 1905 specifies one voice vector of the string of the feature relating to voice (S2221). For example, the voice vectors are sequentially specified from the head of the string.

The sixth generation unit 1905 converts the voice vector into a numeral value in the same manner as in a case of the third generation processing (S2223). Hence, the sixth generation unit 1905 adds the numeral value to the string of the parameters relating to voice (S2225). The string of the parameters relating to voice is retained as an internal parameter.

The sixth generation unit 1905 determines whether or not there is an unprocessed voice vector (S2227). In a case where it is determined that there is an unprocessed voice vector, the flow returns to the processing illustrated in S2221 and repeats the aforementioned processing.

Meanwhile, in a case where it is determined that there is no unprocessed voice vector, the sixth generation processing ends. If the sixth generation processing ends, the flow returns to the evaluation processing of a caller.

Description of FIG. 20 will be made again. The second application unit 1907 performs the second application processing (S2009). In the second application processing, the second application unit 1907 applies each parameter relating to voice generated in the sixth generation processing to a second model generated in the learning processing. Specifically, the second application unit 1907 sets each parameter relating to voice to a unit of the input layer of the neural network illustrated in FIG. 8. Furthermore, the second application unit 1907 operates the neural network by using a coupling load stored in the second model data storage unit 129. As a result, the second evaluation value relating to voice is output from the unit of the output layer.

The calculation unit 1909 performs calculation processing (S2011). In the calculation processing, an overall third evaluation value is calculated based on the first evaluation value and the second evaluation value. Hereinafter, two examples of the calculation processing will be described.

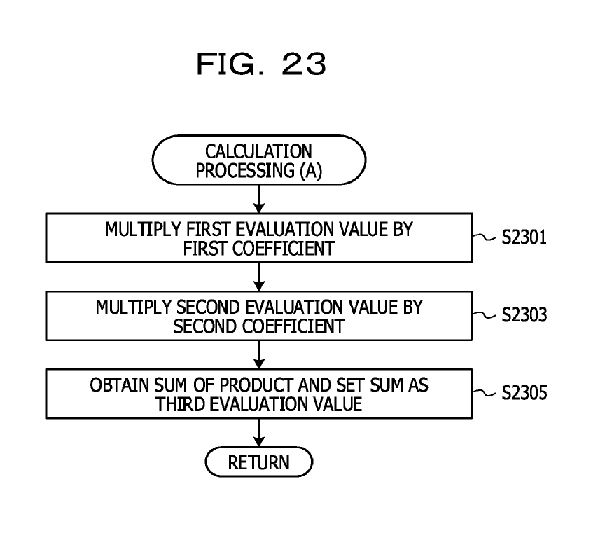

FIG. 23 illustrates a flow of calculation processing (A). The calculation unit 1909 multiplies the first evaluation value by a first coefficient (S2301). The calculation unit 1909 multiplies the second evaluation value by a second coefficient (S2303). The calculation unit 1909 obtains the sum of product calculated in S2301 and product calculated in S2303, and sets the sum as the third evaluation value (S2305). If the calculation processing (A) ends, the flow returns to the evaluation processing of a caller. Meanwhile, the first coefficient corresponds to weight with respect to the first evaluation value. Meanwhile, the second coefficient corresponds to weight with respect to the second evaluation value.

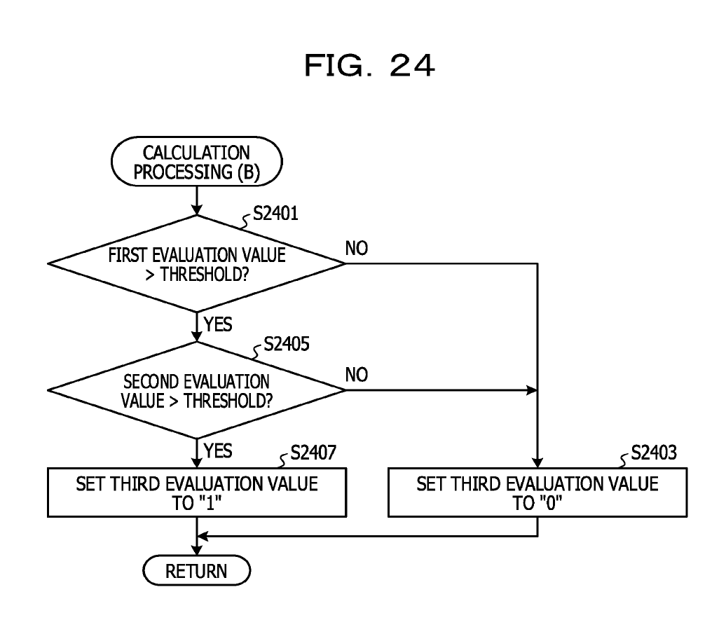

FIG. 24 illustrates a flow of calculation processing (B). In the calculation processing (B), evaluation is performed in two stages. An evaluation value “1” indicates that evaluation of a character string is good. An evaluation value “0” indicates that the evaluation of the character string is bad.

First, the calculation unit 1909 determines whether or not the first evaluation value exceeds a threshold (S2401). In a case where it is determined that the first evaluation value does not exceed the threshold, the calculation unit 1909 sets the third evaluation value to “0” (S2403).

Meanwhile, in a case where the first evaluation value exceeds the threshold, the calculation unit 1909 determines whether or not the second evaluation value exceeds the threshold (S2405). In a case where it is determined that the second evaluation value does not exceed the threshold, the calculation unit 1909 sets the third evaluation value to “0” (S2403).

Meanwhile, in a case where it is determined that the second evaluation value exceeds the threshold, the third evaluation value is set to “1” (S2407).

In this example, in a case where the first evaluation value and the second evaluation value exceed the threshold, the third evaluation value is set to “1”. However, in a case where at least the first evaluation value or the second evaluation value exceeds the threshold, the third evaluation value may be set to “1”. If the calculation processing ends, the flow returns to the evaluation processing of a caller.

Description of FIG. 20 will be made again. The output unit 111 outputs the third evaluation value (S2013).

According to the present embodiment, it is possible to estimate sensitive evaluation of a reader with respect to a character string. For example, it is expected to reflect a rule which is hard to formulate like implicit associations and linguistic rhythms.

In addition, it is possible to reflect semantic impression that a reader receives from a word in a first model.

In addition, it is possible to reflect voice impression that the reader receives from a syllable in a second model.

As such, one embodiment is described, and the embodiment is not limited to this. For example, the aforementioned functional block configuration may not match a program module configuration.

In addition, the configurations of the aforementioned each storage region are examples, and each storage region does not have to be configured as described above. Furthermore, also in the processing flow, the order of processing may be changed or a plurality of processing may be performed in parallel, unless processing results are not changed.

### Second Embodiment

The present embodiment describes an application example relating to a character string in English.

A module configuration of an evaluation apparatus 101 according to a second embodiment is the same (FIG. 1) as in a case of the first embodiment.

FIG. 25 illustrates an example of teacher data according to the second embodiment. A configuration of the teacher data according to the second embodiment is the same as in a case (FIG. 2) of the first embodiment.

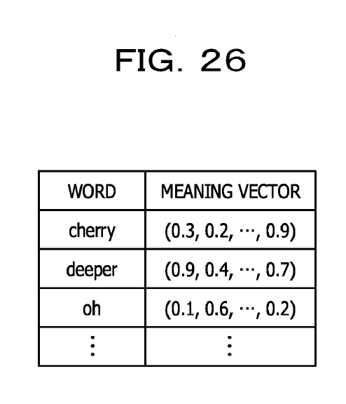

FIG. 26 illustrates an example of a meaning vector database 123 according to the second embodiment. A configuration of the meaning vector database 123 according to the second embodiment is the same as in a case (FIG. 3) of the first embodiment.

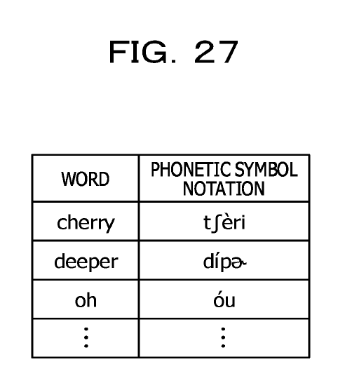

FIG. 27 illustrates an example of a voice notation database 127 according to the second embodiment. In the example, a table of the voice notation database 127 includes a record corresponding to words. The record in the table of the voice notation database 127 includes a field in which words are stored and a field in which phonetic symbol notations are stored.

In the phonetic symbol notation, the reading of the word is represented by phonetic symbols. The voice notation database 127 may store data of waveforms of the voice in addition to a voice notation.

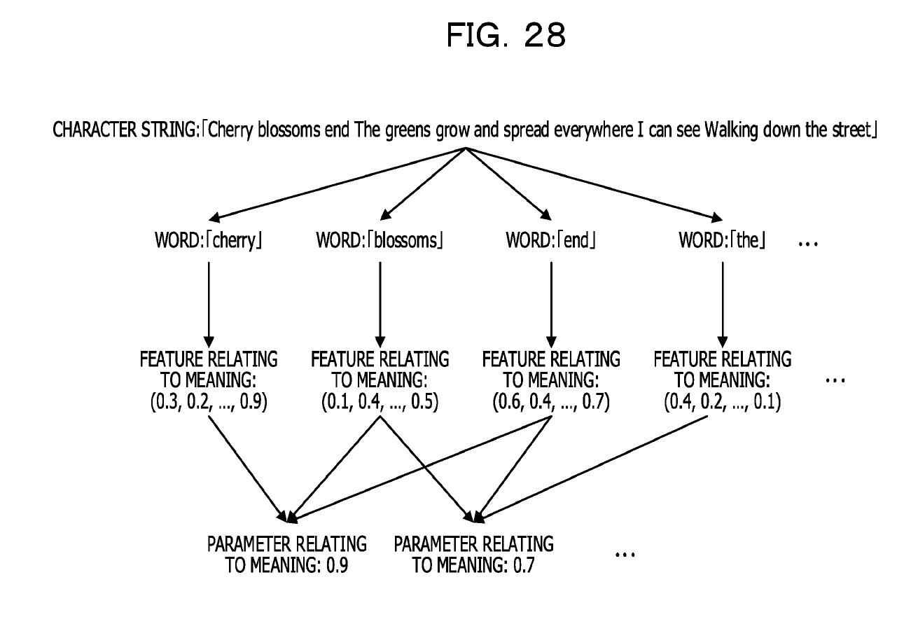

A procedure of calculating parameters relating to meaning in the second embodiment is the same (FIG. 5) as in a case of the first embodiment. FIG. 28 illustrates an example of a procedure of calculating parameters relating to meaning in the second embodiment. First, a character string is divided into words.

Next, each word is converted into a meaning vector corresponding to features relating to meaning. For example, a word “cherry” is converted into the meaning vector (0.3, 0.2, . . . , 0.9). As described above, the meaning vector of each word is registered in the meaning vector database 123 which is prepared in advance.

A configuration of a neural network used for machine learning relating to the meaning in the second embodiment is the same as in a case (FIG. 6) of the first embodiment.

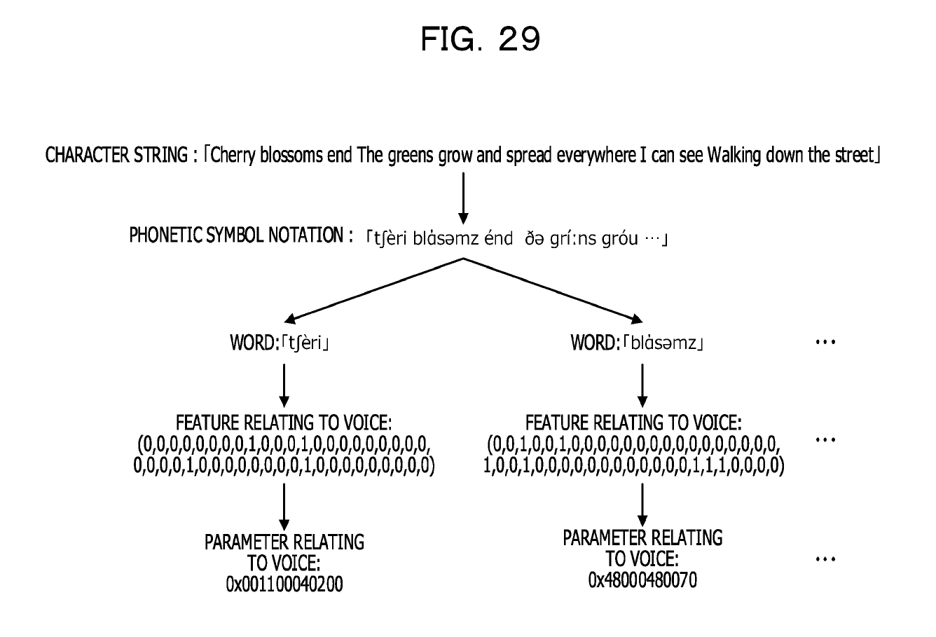

FIG. 29 illustrates a procedure of calculating parameters relating to voice in the second embodiment. First, a character string is converted into phonetic symbol notation.

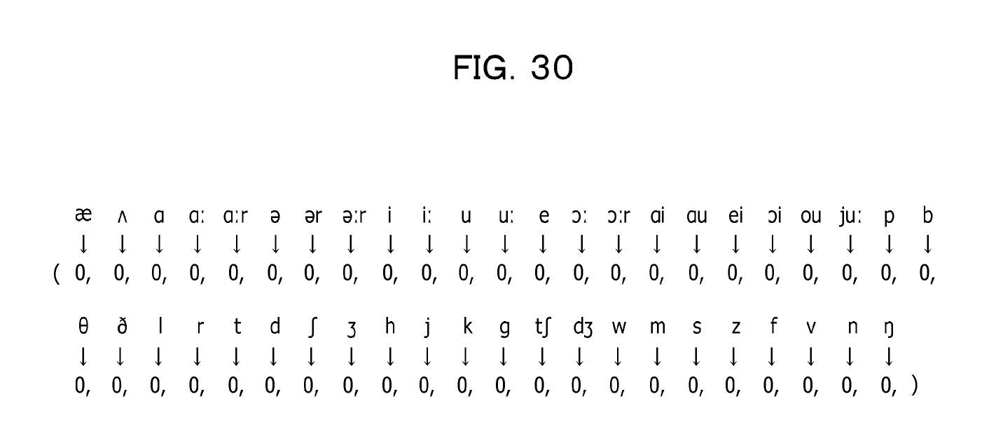

Next, words are extracted from the phonetic symbol notation, and the extracted phonetic symbol notation of each word is converted into features relating to voice. FIG. 30 illustrates an example of the correspondence between vowels and consonants with each element of a voice vector. In this example, the features relating to voice are represented by 45-element voice vectors. Each element included in the voice vector corresponds to a vowel or a consonant. In a case where the phonetic symbol notation of a word includes a vowel or a consonant corresponding to the element, the value of the element is “1”. In this example, in a case of a plurality of the same vowels or consonants, a value of the element corresponding to the vowel or the consonant is set to “1”. However, in a case of a plurality of the same vowels or consonants, the number of the vowels or the consonants may alternatively be set to the value of the element.

The voice vectors which are features relating to the voice are converted into parameters relating to the voice. In this example, each of the 45 elements included in a voice vector corresponds to one digit of a 45-digit binary number. Binary values are converted into hexadecimal values. For example, in a case of the voice vector (0,0,0,0,0,0,0,0,1,0,0,0,1,0,0,0,0,0,0,0,0,0,0,0,0,0,1,0,0,0,0,0,0,0,0,1,0,0,0,0,0,0,0,0,0) which is a first feature relating to the voice, the binary number “000000001000100000000000001000000001000000000” is converted to the hexadecimal number “0x001100040200”. The hexadecimal number “0x001100040200” is a first parameter relating to the voice.

A configuration of a neural network used for the machine learning relating to voice in the second embodiment is the same as in a case of the first embodiment (FIG. 8).

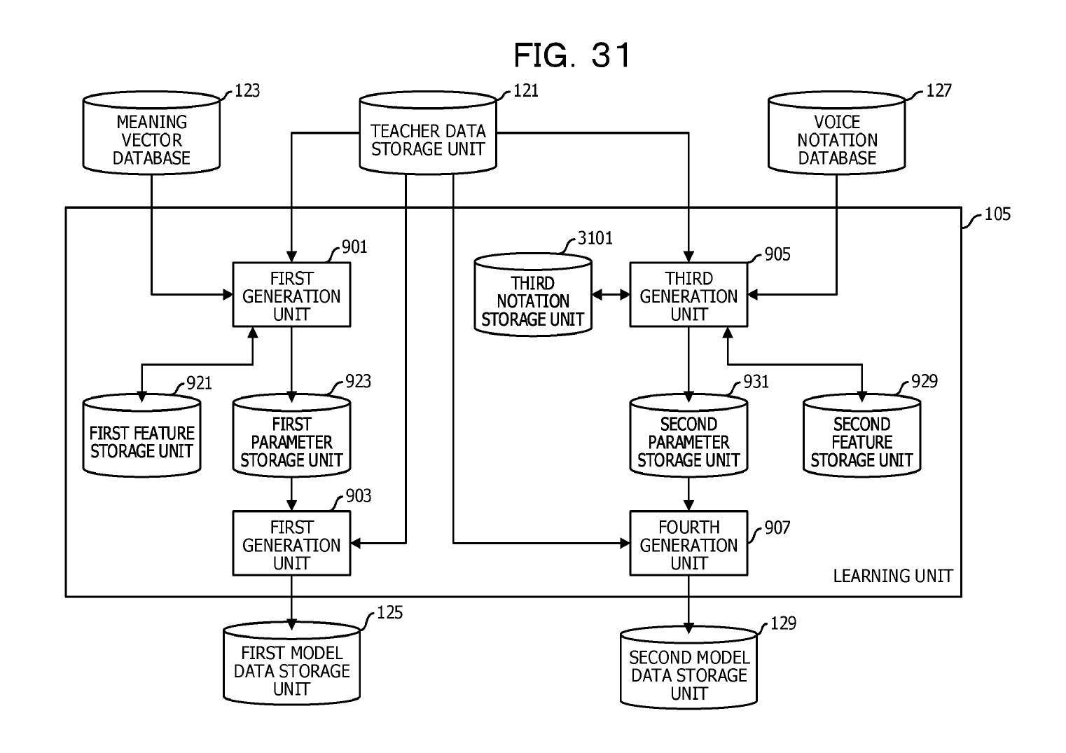

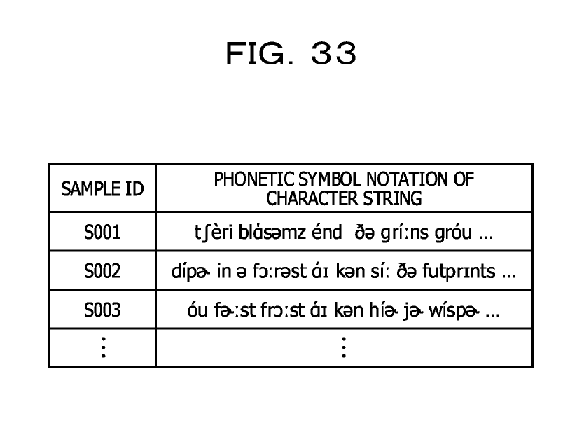

FIG. 31 illustrates a module configuration example of a learning unit 105 according to the second embodiment. The learning unit 105 according to the second embodiment includes a third notation storage unit 3101 instead of the first notation storage unit 925 and the second notation storage unit 927. The third notation storage unit 3101 stores a third notation table. The third notation table will be described below with reference to FIG. 33.

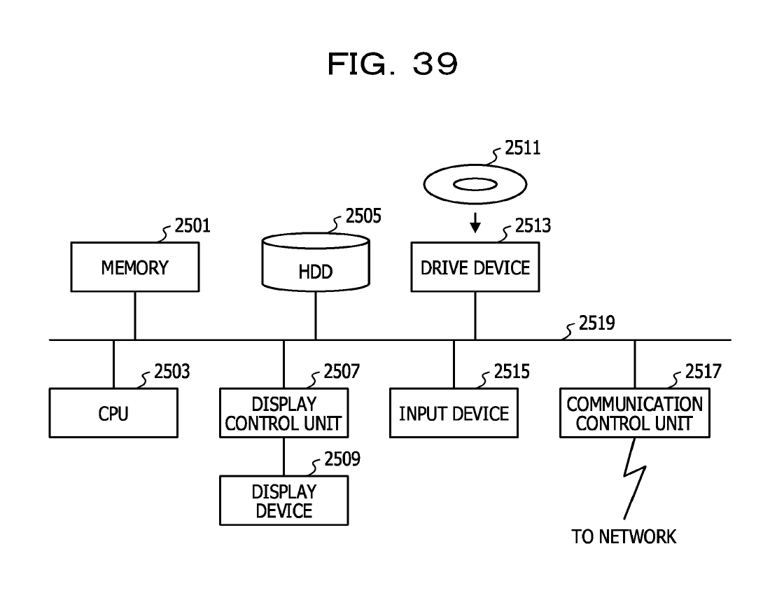

The third notation storage unit 3101 is realized by using hardware resources (for example, FIG. 39).

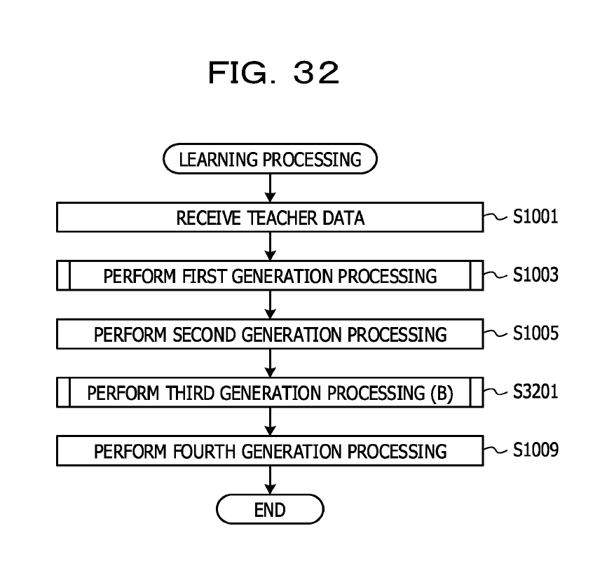

A third generation unit 905 performs third generation processing (B) instead of the third generation processing (A). FIG. 32 illustrates a learning processing flow according to the second embodiment. A first reception unit 103 receives the teacher data in the same manner as in a case of the first embodiment (S1001). The received teacher data is stored in the teacher data storage unit 121.

A first generation unit 901 performs first generation processing in the same manner as in a case of the first embodiment (S1003).

The first generation processing is the same as in a case (FIGS. 13A and 13B) of the first embodiment. Meanwhile, a configuration of a first feature table is the same as in a case (FIG. 11) of the first embodiment. In addition, a configuration of a first parameter table is the same as in a case (FIG. 12) of the first embodiment.

Second generation processing is also the same as in a case of the first embodiment.

The third generation unit 905 performs the third generation processing (B) (S3201). Before describing the third generation processing (B), the third notation table, a second feature table, and a second parameter table will be described.

FIG. 33 illustrates an example of the third notation table. The third notation table according to this example has a record corresponding to a sample. The record of the third notation table has a field in which a sample ID is stored and a field in which the phonetic symbol notation of the character string is stored.

The sample ID identifies the sample. In the phonetic symbol notation of the character string, the reading of the character string of the sample is represented by phonetic symbols.

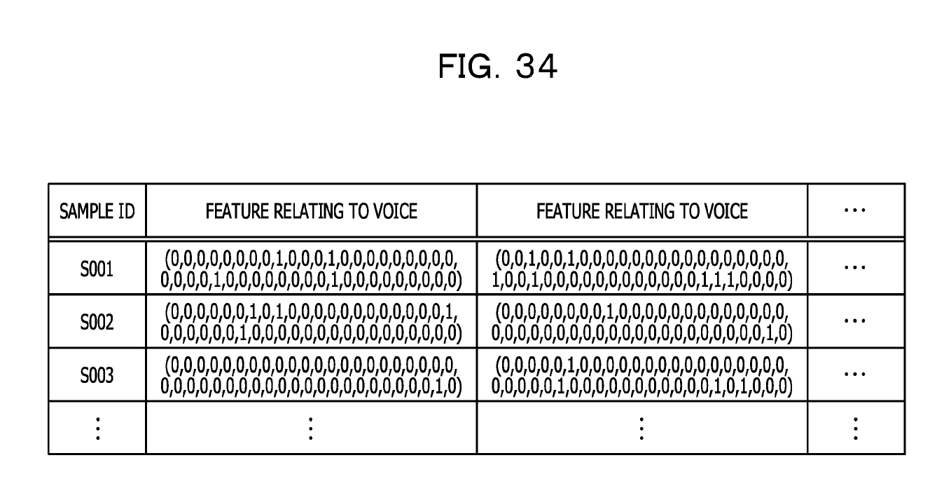

A configuration of the second feature table according to the second embodiment is the same as in a case (FIG. 16) of the first embodiment. FIG. 34 illustrates an example of the second feature table according to the second embodiment.

For example, the illustrated first record indicates that a first word of the first sample is represented by the voice vector (0,0,0,0,0,0,0,0,1,0,0,0,1,0,0,0,0,0,0,0,0,0,0,0,0,0,1,0,0,0,0,0,0,0,0,1,0,0,0,0,0,0,0,0,0).

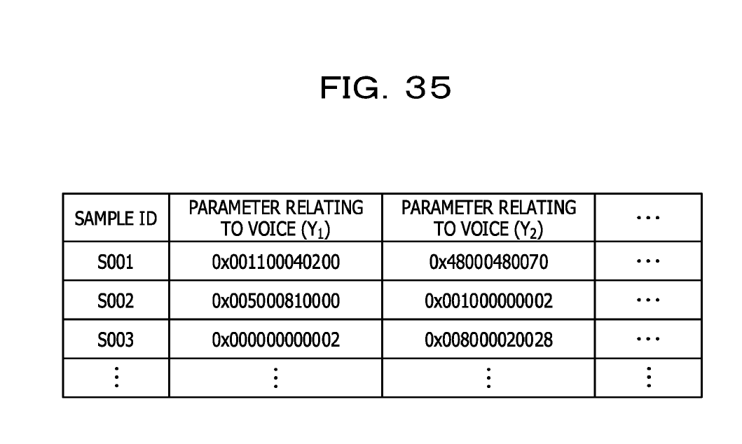

A configuration of the second parameter table according to the second embodiment is the same as in a case (FIG. 17) of the first embodiment. FIG. 35 illustrates an example of the second parameter table according to the second embodiment.

For example, the illustrated first record indicates that the parameter based on the feature of the first word included in a character string identified by a sample ID “S001” is a hexadecimal number “0x001100040200”.

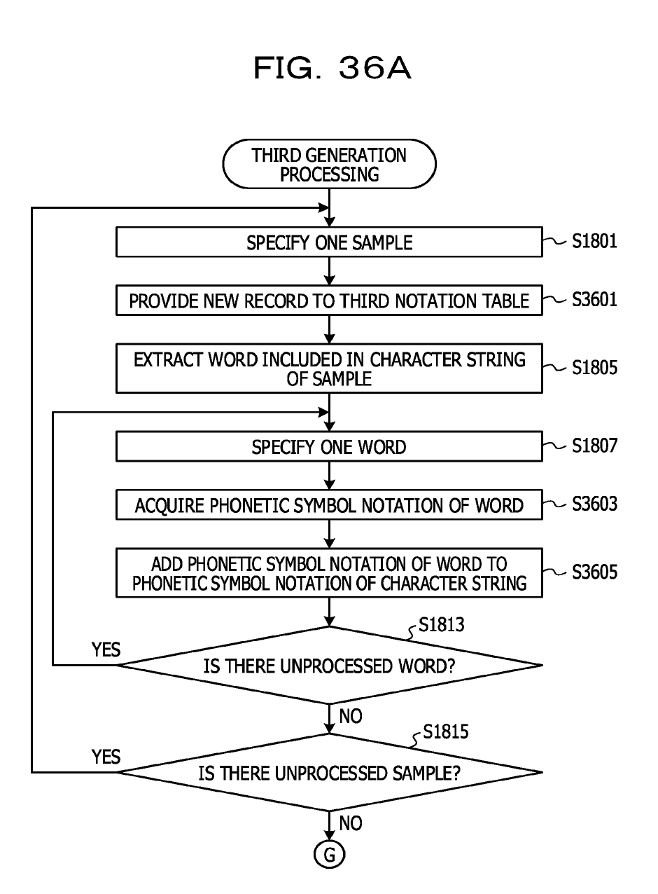

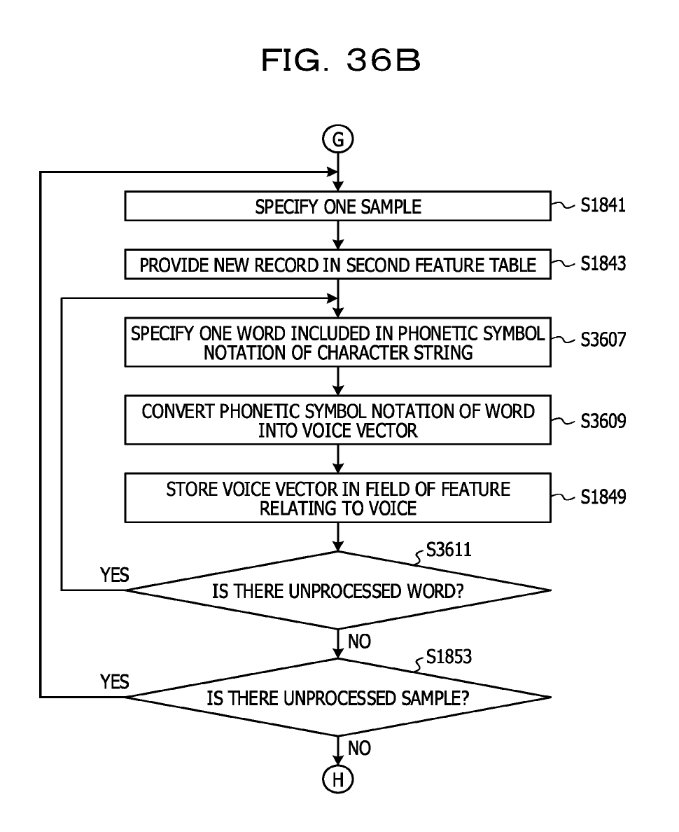

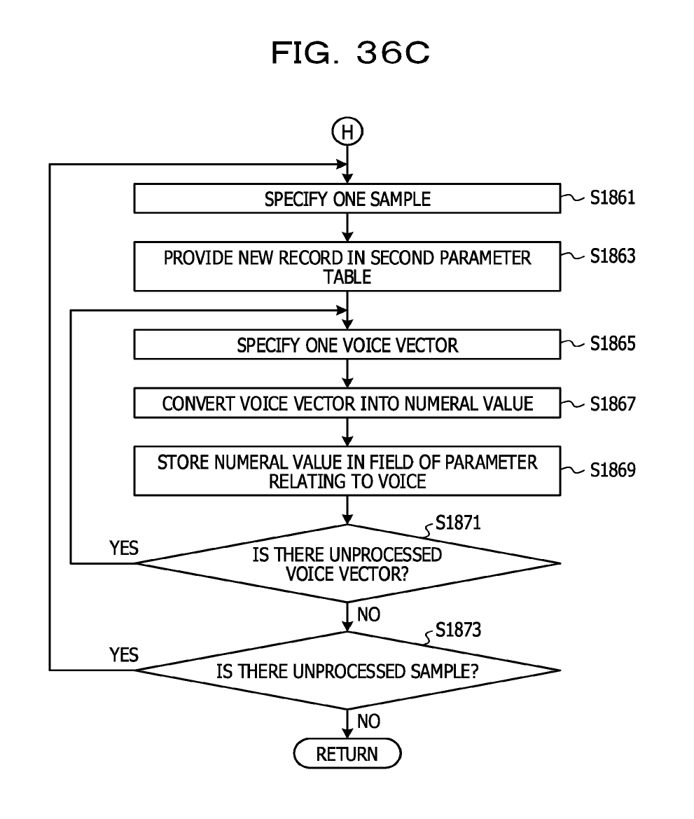

Next, the third generation processing (B) will be described. FIG. 36A illustrates a third generation processing (B) flow. The third generation unit 905 specifies one sample (S1801) in the same manner as in a case (FIG. 18A) of the first embodiment. For example, the third generation unit 905 specifies sample IDs in ascending order.

The third generation unit 905 provides a new record to the third notation table (S3601). The sample ID specified in S1801 is stored in the new record.

The third generation unit 905 extracts words included in the character string of the sample (S1805). For example, the third generation unit 905 performs morphological analysis thereby dividing the character string into a plurality of words.

The third generation unit 905 specifies one word which is extracted (S1807) in the same manner as in a case of the first embodiment. Specifically, the first generation unit 901 sequentially specifies the divided words from the head.

The third generation unit 905 acquires the phonetic symbol notation of each of the words from the voice notation database 127 (S3603). Hence, the third generation unit 905 adds the phonetic symbol notation of each of the words to the field of the phonetic symbol notation of the character string provided in S3601 (S3605).

The third generation unit 905 determines whether or not there is an unprocessed word among the words extracted in S1805 (S1813). In a case where it is determined that there is an unprocessed word, the flow returns to the processing illustrated in S1807, and repeats the aforementioned processing.

Meanwhile, in a case where it is determined that there is no unprocessed word, the third generation unit 905 determines whether or not there is an unprocessed sample (S1815). In a case where it is determined that there is an unprocessed sample, the flow returns to the processing illustrated in S1801, and repeats the aforementioned processing.

Meanwhile, in a case where it is determined that there is no unprocessed sample, the flow proceeds to processing of S1841 illustrated in FIG. 36B through a terminal G. At a point of time when it is determined that there is no unprocessed sample, generation of the third notation table is completed.

Description of FIG. 36B will be made. In the following processing, the second feature table is generated. The third generation unit 905 specifies one sample (S1841) in the same manner as in a case (FIG. 18C) of the first embodiment. For example, the third generation unit 905 specifies sample IDs in ascending order.

The third generation unit 905 provides a new record to the second feature table (S1843) in the same manner as in a case of the first embodiment. The sample ID specified in S1841 is stored in the new record.

The third generation unit 905 specifies one word denoted by the phonetic symbol notation of the character string (S3607). In this example, the third generation unit 905 sequentially specifies words from front to back.

The third generation unit 905 converts the phonetic symbol notation of the word into a voice vector (S3609). A value of an element corresponding to a vowel included in the phonetic symbol notation of the word is set to “1”. In a case where the phonetic symbol notation of the word includes a consonant, the value of the element corresponding to the consonant is set to “1”. Values of other elements are set to “0”.

The third generation unit 905 sequentially stores the voice vector in the field of features relating to the voice in the record provided in S1843 (S1849).

The third generation unit 905 determines whether or not there is an unprocessed word (S3611). In a case where it is determined that there is an unprocessed word, the flow returns to the processing illustrated in S3607, and repeats the aforementioned processing.

Meanwhile, in a case where it is determined that there is no unprocessed word, the third generation unit 905 determines whether or not there is an unprocessed sample (S1853). In a case where it is determined that there is an unprocessed sample, the flow returns to the processing illustrated in S1841 and repeats the aforementioned processing.

Meanwhile, in a case where it is determined that there is no unprocessed sample, the flow proceeds to the processing of S1861 illustrated in FIG. 36C through a terminal H. At a point of time when it is determined that there is no unprocessed sample, generation of the second feature table is completed.

Description of FIG. 36C will be made. In the following processing, the second parameter table is generated. The third generation unit 905 specifies one sample (S1861) in the same manner as in a case (FIG. 18D) of the first embodiment. For example, the third generation unit 905 specifies the sample IDs in ascending order.

The third generation unit 905 provides a new record in the second parameter table (S1863) in the same manner as in a case of the first embodiment. The sample ID specified in S1861 is stored in the new record.

The third generation unit 905 specifies one voice vector stored in the field of the feature relating to voice in the record of the sample in the second feature table (S1865) in the same manner as in a case of the first embodiment. Specifically, the third generation unit 905 sequentially specifies the field of the feature relating to voice from front to back and reads the vector stored in the field.

The third generation unit 905 converts the voice vector into a numeral value (S1867). As described above, the third generation unit 905 performs processing so that each of the 45 elements included in a voice vector corresponds to one digit of a 45-digit binary number and binary values of 45 digits are converted into hexadecimal values.

The third generation unit 905 sequentially stores the numeral values in the field of the parameter relating to the voice provided in S1863 (S1869).

The third generation unit 905 determines whether or not there is an unprocessed voice vector (S1871). In a case where it is determined that there is an unprocessed voice vector, the flow returns to the processing illustrated in S1865 and repeats the aforementioned processing.

Meanwhile, in a case where it is determined that there is no unprocessed voice vector, the third generation unit 905 determines whether or not there is an unprocessed sample (S1873). In a case where it is determined that there is an unprocessed sample, the flow returns to the processing illustrated in S1861 and repeats the aforementioned processing.

Meanwhile, in a case where it is determined that there is no unprocessed sample, the third generation processing (B) ends. At a point of time when it is determined that there is no unprocessed sample, generation of the second parameter table is completed. If the third generation processing (B) ends, the flow returns to the learning processing of a caller.

Description of FIG. 32 will be made. Fourth generation processing is the same as in a case of the first embodiment (S1009).

Next, an operation of the evaluation unit 109 will be described. A module configuration of the evaluation unit 109 according to the second embodiment is the same as in a case (FIG. 19) of the first embodiment.

The sixth generation unit 1905 performs sixth generation processing (B). In the sixth generation processing (B), parameters relating to voice are generated based on features relating to the voice of each word included in a character string which is evaluated.

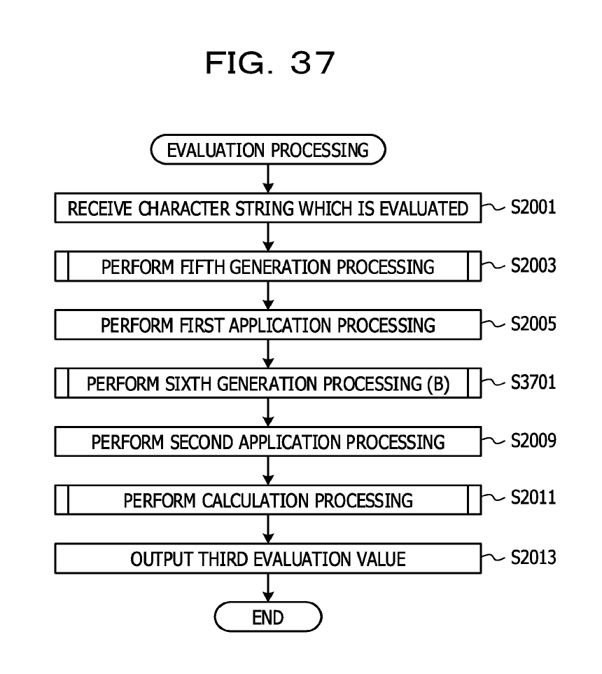

FIG. 37 illustrates an evaluation processing flow according to the second embodiment. The second reception unit 107 receives the character string which is evaluated (S2001) in the same manner as in a case (FIG. 20) of the first embodiment. The received character string is retained as an internal parameter.

The fifth generation unit 1901 performs fifth generation processing (S2003) in the same manner as in a case of the first embodiment.

The first application unit 1903 performs first application processing (S2005) in the same manner as in a case of the first embodiment.

The sixth generation unit 1905 performs sixth generation processing (B) (S3701). In the sixth generation processing (B), parameters relating to voice are generated based on the features relating to the voice of each word included in the character string which is evaluated. The parameters are generated by the same procedure as in a case of the third generation processing (B) of the learning processing.

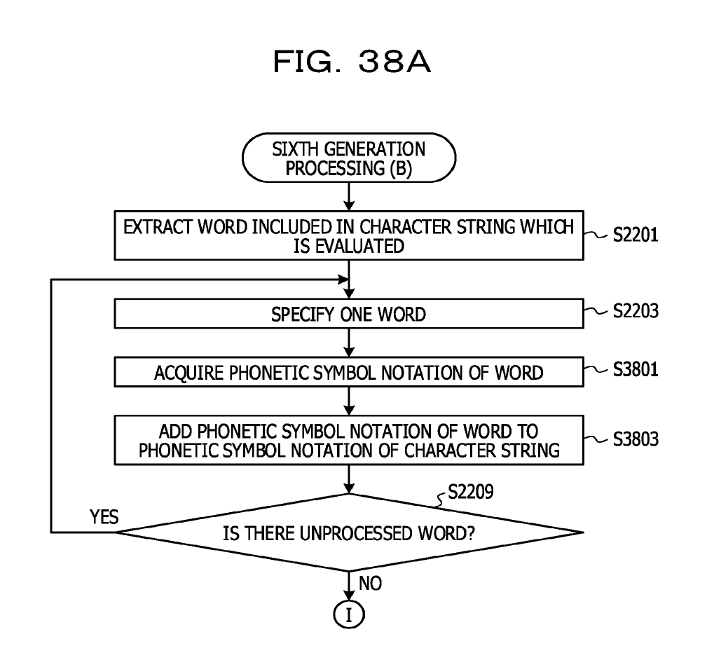

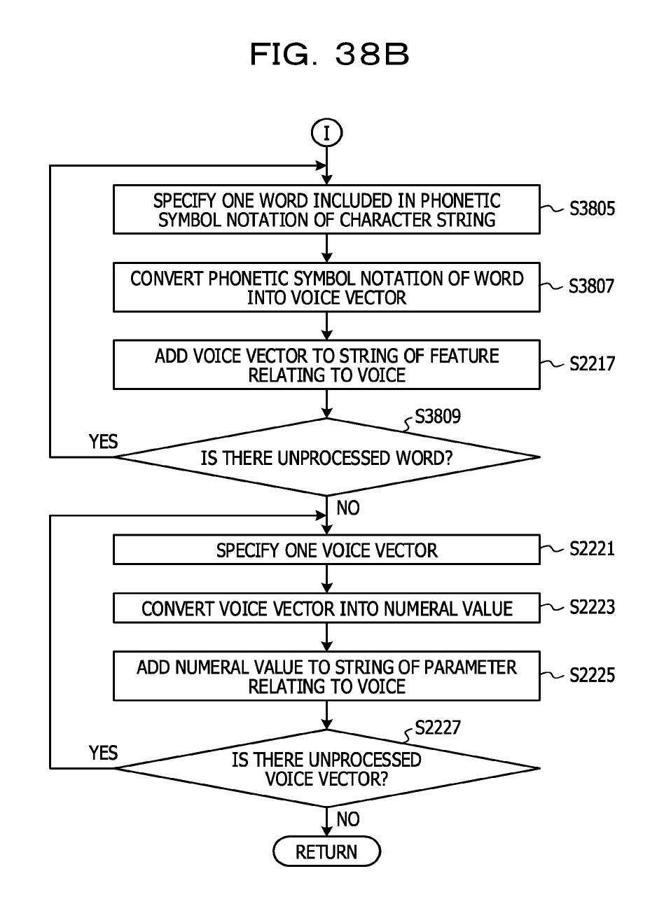

FIG. 38A illustrates the sixth generation processing (B) flow. The sixth generation unit 1905 extracts words included in the character string which is evaluated (S2201). For example, the sixth generation unit 1905 performs morphological analysis thereby dividing the character string into a plurality of words.

The sixth generation unit 1905 specifies one word (S2203). For example, the sixth generation unit 1905 sequentially specifies the divided words from the head.

The sixth generation unit 1905 acquires phonetic symbol notation of the words from the voice notation database 127 (S3801). The sixth generation unit 1905 adds the phonetic symbol notation of the words to the phonetic symbol notation of the character string (S3803). The phonetic symbol notation of the character string is retained as an internal parameter.

The sixth generation unit 1905 determines whether or not there is an unprocessed word (S2209). In a case where it is determined that there is an unprocessed word, the flow returns to the processing illustrated in S2203 and repeats the aforementioned processing.

Meanwhile, in a case where it is determined that there is no unprocessed word, the flow proceeds to processing of S3805 illustrated in FIG. 38B through the terminal I.

Description of FIG. 38B will be made. The sixth generation unit 1905 specifies one word denoted by phonetic symbol notation of a character string (S3805). In this example, the sixth generation unit 1905 sequentially specifies the words from front to back.

The sixth generation unit 1905 converts the phonetic symbol notation of the word into a voice vector in the same manner as in a case of the third generation processing (B) (S3807). The sixth generation unit 1905 adds the voice vectors to a string of the feature relating to the voice (S2217). The string of the feature relating to the voice is specifically a string of voice vectors and is retained as an internal parameter.

The sixth generation unit 1905 determines whether or not there is an unprocessed word (S3809). In a case where it is determined that there is an unprocessed word, the flow returns to the processing illustrated in S3805 and repeats the aforementioned processing.

Meanwhile, in a case where it is determined that there is no unprocessed word, the sixth generation unit 1905 specifies one voice vector in the string of the feature relating to the voice (S2221). For example, the voice vectors are sequentially specified from the head of the string.

The sixth generation unit 1905 converts the voice vector into a numeral value in the same manner as in a case of the third generation processing (B) (S2223). Hence, the sixth generation unit 1905 adds the numeral value to the string of the parameters relating to the voice (S2225). The string of the parameters relating to the voice is retained as internal parameters.

The sixth generation unit 1905 determines whether or not there is an unprocessed voice vector (S2227). In a case where it is determined that there is an unprocessed voice vector, the flow returns to the processing illustrated in S2221 and repeats the aforementioned processing.

Meanwhile, in a case where it is determined that there is no unprocessed voice vector, the sixth generation processing (B) ends. If the sixth generation processing (B) ends, the flow returns to the evaluation processing of a caller.

Description of FIG. 37 will be made. The second application unit 1907 performs second application processing (S2009) in the same manner as in a case (FIG. 20) of the first embodiment.

The calculation unit 1909 performs calculation processing (S2011) in the same manner as in a case of the first embodiment. In the calculation processing, an overall third evaluation value is calculated based on the first evaluation value and the second evaluation value. In the second embodiment, the calculation unit 1909 may perform the calculation processing (A) illustrated in FIG. 23 or the calculation processing (B) illustrated in FIG. 24.

The output unit 111 outputs a third evaluation value (S2013) in the same manner as in a case of the first embodiment.

According to the present embodiment, it is possible to estimate sensitive evaluation of a reader with respect to a character string. For example, it is expected to reflect a rule which is hard to formulate like implicit associations and linguistic rhythms.

In addition, it is possible to reflect semantic impression that a reader receives from a word in a first model.

In addition, it is possible to reflect voice impression that the reader receives from a word in a second model.

Furthermore, feature of voice of a character string may be based on voice of each of a plurality of words included in the character string.

By doing so, it is possible to reflect voice impression that a reader receives from a word in a second model.

The evaluation apparatus 101 is a computer device, and as illustrated in FIG. 39, a memory 2501, a central processing unit (CPU) 2503, a hard disk drive (HDD) 2505, a display control unit 2507 connected to a display device 2509, a drive device 2513 for a removable disk 2511, an input device 2515, a communication control unit 2517 for being connected to a network, are connected to a bus 2519. An operating system (OS) and an application program for performing the processing according to the embodiment are stored in the HDD 2505, and are read from the HDD 2505 to the memory 2501, when being executed by the CPU 2503. The CPU 2503 controls the display control unit 2507, the communication control unit 2517, and the drive device 2513 in accordance with processing content of the application program to perform a predetermined operation. In addition, data which is processed is mainly stored in the memory 2501, but may be stored in the HDD 2505. In the embodiment, the application program for performing the aforementioned processing is stored in the computer-readable removable disk 2511, is distributed, and is installed from the drive device 2513 to the HDD 2505. The application program may be installed in the HDD 2505 via a network such as the Internet and the communication control unit 2517. The computer performs the aforementioned each function, as hardware such as the CPU 2503 and the memory 2501 and programs such as an OS and an application program cooperate with each other in an organic manner.

The aforementioned embodiments may be summarized as follows.

An evaluation method according to the present embodiment includes (A) generating a first model which derives an evaluation value based on feature of meaning of a character string by using teacher data including a plurality of samples in which a character string and an evaluation value are associated with each other, (B) generating a second model which derives an evaluation value based on feature of voice of a character string by using the teacher data, and (C) calculating a third evaluation value, based on a first evaluation value derived by applying the feature of meaning of a character string which is evaluated to the first model, and a second evaluation value derived by applying the feature of voice of the character string which is evaluated to the second model.

By doing so, it is possible to estimate sensitive evaluation of a reader with respect to a character string.

Furthermore, feature of meaning of a character string may be based on meaning of each of a plurality of language units included in the character string.

By doing so, it is possible to reflect semantic impression that a reader receives from the language unit to a first model.

Furthermore, feature of voice of a character string may be based on voice of each of a plurality of syllables included in the character string.

By doing so, it is possible to reflect voice impression that a reader receives from a syllable in a second model.

It is possible to create a program of performing processing which is performed by the aforementioned method by using a computer, and the program may be stored in a computer-readable storage medium, such as a flexible disk, a CD-ROM, a magneto-optical disk, a semiconductor memory, and a hard disk, or a storage device. Meanwhile, intermediate processing results are temporarily stored in a storage device such as a main memory in general.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An evaluation device comprising:
a memory; and
a processor coupled to the memory and the processor configured to:
acquire a first character string,
specify features of first meaning information and features of first sound information, the first meaning information corresponding to meanings denoted by the first character string, the first sound information corresponding to sounds denoted by the first character string,
determine a first evaluation value based on the features of the first meaning information,
determine a second evaluation value based on the features of the first sound information, and
output an evaluation value of the first character string based on the first evaluation value and the second evaluation value.

2. The evaluation device according to claim 1, wherein the features of the first meaning information is based on each meaning that is denoted by each of a plurality of portions which are included in the first character string.

3. The evaluation device according to claim 1, wherein the features of the first sound information is based on each sound that is denoted by each of a plurality of syllables which are included in the first character string.

4. The evaluation device according to claim 1, wherein the features of the first sound information is based on each sound that is denoted by each of a plurality of words which are included in the first character string.

5. The evaluation device according to claim 1, wherein the processor is configured to,
acquire a plurality of character strings and a plurality of evaluation values corresponding to the plurality of character strings,
specify features of pieces of meaning information corresponding to meanings are denoted by each of the plurality of character strings, and
generate a first rule based on the plurality of evaluation values and the features of the pieces of meaning information, the first rule being used for determining the first evaluation value from the features of the first meaning information.

6. The evaluation device according to claim 5, wherein the first evaluation value is determined in accordance with the first rule.

7. The evaluation device according to claim 1, wherein the processor is configured to,
acquire a plurality of character strings and a plurality of evaluation values corresponding to the plurality of character strings,
specify features of pieces of sound information corresponding to sounds denoted by each of the plurality of character strings, and
generate a second rule based on the plurality of evaluation values and the features of the pieces of sound information, the second rule being used for determining the second evaluation value from the features of the first sound information.

8. The evaluation device according to claim 7, wherein the second evaluation value is determined in accordance with the second rule.

9. An evaluation method executed by a computer, the method comprising:
acquiring a first character string;
specifying features of first meaning information and features of first sound information, the first meaning information corresponding to meanings denoted by the first character string, the first sound information corresponding to sounds denoted by the first character string;
determining a first evaluation value based on the features of the first meaning information;
determining a second evaluation value based on the features of the first sound information; and
outputting an evaluation value of the first character string based on the first evaluation value and the second evaluation value.

10. The evaluation method according to claim 9, wherein the features of the first meaning information is based on each meaning denoted by each of a plurality of portions which are included in the first character string.

11. The evaluation method according to claim 10, wherein the portions include at least one of a word, a clause, or a sentence.

12. The evaluation method according to claim 9, wherein the features of the first sound information is based on each sound denoted by each of a plurality of syllables which are included in the first character string.

13. The evaluation method according to claim 9, wherein the features of the first sound information is based on each sound denoted by each of a plurality of words which are included in the first character string.

14. A non-transitory computer-readable storage medium storing a program that causes a computer to execute an evaluation process comprising:
acquiring a first character string;
specifying features of first meaning information and features of first sound information, the first meaning information corresponding to meanings denoted by the first character string, the first sound information corresponding to sounds denoted by the first character string;
determining a first evaluation value based on the features of the first meaning information;
determining a second evaluation value based on the features of the first sound information; and
outputting an evaluation value of the first character string based on the first evaluation value and the second evaluation value.
